(19) United States
(12) Patent Application Publication
(10) Pub. No.: US 2024/0056865 A1
(43) Pub. Date: Feb. 15, 2024

(54) USER EQUIPMENT, BASE STATION AND METHOD PERFORMED BY THE SAME IN WIRELESS COMMUNICATION SYSTEM

(71) Applicant: Samsung Electronics Co., Ltd., Suwon-si, Gyeonggi-do (KR)

(72) Inventors: Feifei SUN, Beijing (CN); Zhe CHEN, Beijing (CN); He WANG, Beijing (CN); Songhui SHEN, Beijing (CN); Liying ZHOU, Beijing (CN)

(21) Appl. No.: 18/447,973

(22) Filed: Aug. 10, 2023

(30) Foreign Application Priority Data
Aug. 10, 2022 (CN) 202210956612.2
Aug. 19, 2022 (CN) 202211001332.2
Nov. 4, 2022 (CN) 202211378298.0
Nov. 18, 2022 (CN) 202211448414.1
Feb. 13, 2023 (CN) 202310120481.9

(51) Int. Cl. H04W 24/10

(52) U.S. Cl. CPC H04W 24/10

(57) ABSTRACT

The present disclosure relates to a 5G communication system or a 6G communication system for supporting higher data rates beyond a 4G communication system such as long term evolution (LTE). A user equipment (UE), a base station and a method performed by the same in a wireless communication system are provided. The method includes determining a first reference signal set for measurement, performing measurement to obtain one or more measurement results based on the determined first reference signal set, and performing reporting based on the one or more measurement results. The first reference signal set is generated based on a first artificial intelligence (AI) model, or the one or more measurement results are generated based on a second AI model. The present disclosure can reduce resource overhead and power consumption of the UE.

### CROSS-REFERENCE TO RELATED APPLICATIONS

This application is based on and claims priority under 35 U.S.C. § 119 to Chinese Patent Application No. 202210956612.2, filed Aug. 10, 2022, in the Chinese Intellectual Property Office, Chinese Patent Application No. 202211001332.2, filed on Aug. 19, 2022, in the Chinese Intellectual Property Office, Chinese Patent Application No. 202211378298.0, filed on Nov. 4, 2022, in the Chinese Intellectual Property Office, Chinese Patent Application No. 202211448414.1, filed on Nov. 18, 2022, in the Chinese Intellectual Property Office, and Chinese Patent Application No. 202310120481.9, filed on Feb. 13, 2023, in the Chinese Intellectual Property Office, the disclosures of which are incorporated by reference herein in their entirety.

### BACKGROUND

### 1. Field

The disclosure relates to a technical field of wireless communication, and more specifically, to a user equipment, a base station and a method performed by the same in a wireless communication system.

### 2. Description of Related Art

Considering the development of wireless communication from generation to generation, the technologies have been developed mainly for services targeting humans, such as voice calls, multimedia services, and data services. Following the commercialization of 5th-generation (5G) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### SUMMARY

According to at least one embodiment of the disclosure, there is provided a method performed by a user equipment (UE) in a wireless communication system. The method includes determining a first reference signal set for measurement, performing measurement to obtain one or more measurement results based on the determined first reference signal set, and performing reporting based on the one or more measurement results. The first reference signal set is generated based on a first artificial intelligence (AI) model, or the one or more measurement results are generated based on a second AI model.

According to at least one embodiment of the disclosure, there is provided a method performed by a base station in a wireless communication system. The method includes determining a first reference signal set for measurement, wherein the first reference signal set is used by a terminal to perform measurement to obtain one or more measurement results, and receiving a reporting of the one or more measurement results from a user equipment (UE). The first reference signal set is generated based on a first AI model, or the one or more measurement results are generated based on a second AI model.

According to at least one embodiment of the disclosure, there is further provided a user equipment (UE) in a wireless communication system. The UE includes a transceiver, and at least one processor coupled with the transceiver and configured to determine a first reference signal set for measurement, perform measurement to obtain one or more measurement results based on the determined first reference signal set, and perform reporting based on the one or more measurement results. The first reference signal set is generated based on a first AI model, or the one or more measurement results are generated based on a second AI model.

According to at least one embodiment of the disclosure, there is further provided a base station in a wireless communication system. The base station includes a transceiver and at least one processor coupled with the transceiver and configured to determine a first reference signal set for measurement, wherein the first reference signal set is used by a terminal to perform measurement to obtain one or more measurement results; and receive a reporting of the one or more measurement results from a UE. The first reference signal set is generated based on a first AI model, or the one or more measurement results are generated based on a second AI model.

According to at least one embodiment of the disclosure, there is further provided a computer-readable storage medium having stored thereon one or more computer programs that, when executed by one or more processors, can implement any one of the methods described above.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

In order to explain the technical schemes of the embodiments of the disclosure more clearly, the drawings of the embodiments of the disclosure will be briefly introduced below. It is apparent that the drawings described below only relate to some embodiments of the disclosure, and do not limit the disclosure. In the drawings:

FIG. 1 illustrates a wireless network according to an embodiment of the present disclosure;

FIGS. 2A and 2B illustrate a wireless transmission and reception paths according to an embodiment of the present disclosure;

FIG. 3A illustrates a UE according to an embodiment of the present disclosure;

FIG. 3B illustrates a gNB according to an embodiment of the present disclosure;

FIG. 4 illustrates a flowchart of a method performed by a UE in a communication system according to an embodiment of the present disclosure;

FIG. 5A illustrates a set of beams for measurement and a set of potential transmit beams according to an embodiment of the present disclosure;

FIG. 5B illustrates a set of beams for measurement according to an embodiment of the present disclosure;

FIG. 6 illustrates an AI model according to an embodiment of the present disclosure;

FIG. 7 illustrates a relationship between a wide beam and a narrow beam according to an embodiment of the present disclosure;

FIG. 8 illustrates a method for obtaining an optimal beam in a set of potential transmit beams based on a measurement set according to an embodiment of the present disclosure;

FIG. 9 illustrates a flowchart of a method performed by a UE according to an embodiment of the present disclosure;

FIG. 10 illustrates a terminal according to an embodiment of the present disclosure; and

FIG. 11 illustrates a base station according to an embodiment of the present disclosure.

### DETAILED DESCRIPTION

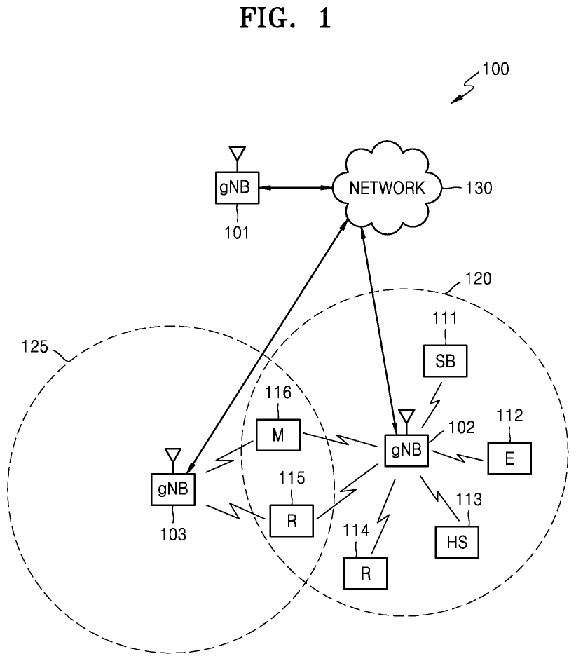

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

In order to make the purposes, technical schemes and advantages of the embodiments of the disclosure clearer, the technical schemes of the embodiments of the disclosure will be described clearly and completely in conjunction with the drawings. It is apparent that the described embodiment is a part of the embodiments of the disclosure but not all the embodiments. Based on the described embodiments of the disclosure, all other embodiments obtained by those of ordinary skill in the art without creative labor belong to the scope of protection of the disclosure.

Before the following description of the specific implementations, it may be beneficial to clarify the definitions of certain words and phrases used throughout this patent document. The term “couple” and its derivatives refer to any direct or indirect communication between two or more elements, whether or not these elements are in physical contact with each other. The terms “transmit,” “receive” and “communicate” and their derivatives cover direct and indirect communication. The terms “include” and “contain” and their derivatives mean including but not limited to. The term “or” is inclusive, meaning and/or. The phrase “associated with” and its derivatives are meant to include, included in, connect to, interconnect with, contain, contained in, connect to or connect with, couple to or couple with, communicative with, cooperate with, interweave, juxtapose, approach, bind to or be bound with, have, have a property of, have a relationship or have a relationship with, etc. The term “controller” means any device, system or part thereof that controls at least one operation. Such a controller may be implemented in hardware or in a combination of hardware and software and/or firmware. The functions associated with any particular controller can be centralized or distributed locally or remotely. The phrase “at least one of . . . ” when used with a list of items means that different combinations of one or more listed items can be used, and only one item in the list may be needed. For example, “at least one of A, B and C” includes any one of the following combinations: A, B, C, A and B, A and C, B and C, and A and B and C. For example, “at least one of A, B or C” includes any one of the following combinations: A, B, C, A and B, A and C, B and C, and A and B and C.

In addition, various functions described below can be implemented or supported by one or more computer programs, each of which is formed by computer-readable program code and embodied in a computer-readable medium. The terms “application” and “program” refer to one or more computer programs, software components, instruction sets, procedures, functions, objects, classes, instances, related data or parts thereof suitable for implementation in suitable computer-readable program code. The phrase “computer readable program code” includes any type of computer code, including source code, object code and executable code. The phrase “computer readable medium” includes any type of medium that can be accessed by a computer, such as Read-Only Memory (ROM), Random Access Memory (RAM), hard disk drive, compact disk (CD), digital video disk (DVD) or any other type of memory. A “non-transitory” computer-readable medium excludes wired, wireless, optical or other communication links that transmit transitory electrical or other signals. Non-transitory computer-readable media include media that can store data permanently and media that can store and rewrite data later, such as rewritable optical disks or erasable memory devices.

The terminology used herein to describe embodiments of the disclosure is not intended to limit and/or restrict the scope of the disclosure. For example, unless otherwise defined, technical terms or scientific terms used in the disclosure should have their ordinary meanings as understood by those of ordinary skills in the art to which the disclosure belongs.

The terms “first,” “second” and similar words used in the disclosure do not indicate any order, quantity or importance, but are only used to distinguish different components. Unless the context clearly indicates otherwise, similar words such as “a,” “an” or “the” in a singular form do not indicate a quantitative limitation, but indicate the existence of at least one. For example, a reference to a “component surface” includes a reference to one or more such surfaces.

As used herein, any reference to “an example” or “example,” “an embodiment” or “embodiment” means that a particular element, feature, structure or characteristic described in connection with this embodiment is included in at least one embodiment. The appearances of the phrases “in an embodiment” or “in an example” in different places in the specification are not necessarily all referring to the same embodiment.

As used herein, “a part” of something means “at least some” of it, so it may mean less than all of it or all of it. Therefore, “a part” of a thing includes the whole thing as a special case, that is, the whole thing is an example of a part of a thing.

As used herein, the term “set” means one or more. Therefore, a set of items may be a single item or a set of two or more items. It should be noted that two sets (for example, sets A and B) are different may mean that at least one element in one set (for example, set A) is different from at least one element in another set (for example, set B).

In the disclosure, expressions such as “greater than” or “less than” are used as examples in order to determine whether certain conditions are met, and expressions such as “greater than or equal to” or “less than or equal to” are also applicable and are not excluded. For example, conditions defined by “greater than or equal to” may be replaced by “greater than” (or vice versa), conditions defined by “less than or equal to” may be replaced by “less than” (or vice versa), and/or the like.

The term “include” or “contain” and similar words mean that the elements or objects appearing before the word encompass the elements or objects listed after the word and their equivalents, without excluding other elements or objects. Similar words such as “connect” or “connected” are not limited to physical or mechanical connection, but can include electrical connection, whether direct or indirect. “Up,” “Down,” “Left,” and “Right” are only used to indicate a relative positional relationship. When an absolute position of a described object changes, the relative positional relationship may also change accordingly.

The various embodiments discussed below for describing the principles of the disclosure are for illustration only and should not be construed as limiting the scope of the disclosure in any way. Those skilled in the art will understand that the principles of the disclosure can be implemented in any suitably arranged wireless communication system. For example, although the following detailed description of the embodiments of the disclosure will focus on LTE and 5G communication systems, those skilled in the art can understand that the main points of the disclosure can also be applied to other communication systems with similar technical backgrounds and channel formats with slight modifications without departing from the scope of the disclosure. The technical scheme of the embodiments of the application can be applied to various communication systems, for example, the communication system can include a global system for mobile communications (GSM) system, a code division multiple access (CDMA) system, a wideband code division multiple access (WCDMA) system, general packet radio service (GPRS), a long term evolution (LTE) system, a LTE frequency division duplex (FDD) system, a LTE time division duplex (TDD), a universal mobile telecommunications system (UMTS), a worldwide interoperability for microwave access (WiMAX) communication system, a 5th generation (5G) system or new radio (NR), etc. In addition, the technical schemes of the embodiments of the application can be applied to future-oriented communication technologies. In addition, the technical schemes of the embodiments of the application can be applied to future-oriented communication technologies.

Hereinafter, various embodiments of the disclosure will be described in detail with reference to the drawings. It should be noted that the same reference numerals in different drawings will be used to refer to the same elements that have been described.

FIGS. 1-3B below describe various embodiments implemented by using orthogonal frequency division multiplexing (OFDM) or orthogonal frequency division multiple access (OFDMA) communication technology in a wireless communication system. The descriptions of FIGS. 1-3B are not meant to imply the physics or architecture of the ways in which different embodiments can be implemented. Different embodiments of the disclosure can be implemented in any suitably arranged communication system.

FIG. 1 illustrates wireless network 100 according to an embodiment of the present disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. A gNB 101 communicates with a gNB 102 and a gNB 103. The gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB.” For convenience, the terms “gNodeB” and “gNB” are used in the disclosure to refer to network infrastructure components that provide wireless access for remote terminals. And, depending on the type of the network, other well-known terms such as “mobile station,” “user station,” “remote terminal,” “wireless terminal” or “user apparatus” can be used instead of “user equipment” or “UE.” For example, the terms “terminal,” “user equipment” and “UE” may be used in this patent document to refer to remote wireless devices that wirelessly access the gNB, no matter whether the UE is a mobile device (such as a mobile phone or a smart phone) or a fixed device (such as a desktop computer or a vending machine).

The gNB 102 provides wireless broadband access to the network 130 for a first plurality of user equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. The GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, long term evolution (LTE), LTE-A, WiMAX or other advanced wireless communication technologies.

The dashed lines show approximate ranges of the coverage areas 120 and 125, and the ranges are shown as approximate circles merely for illustration and explanation purposes. The coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In an embodiment, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, the gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, the gNB 101, the gNB 102 and/or the gNB 103 can provide access to other or additional external networks, such as external telephone networks or other types of data networks.

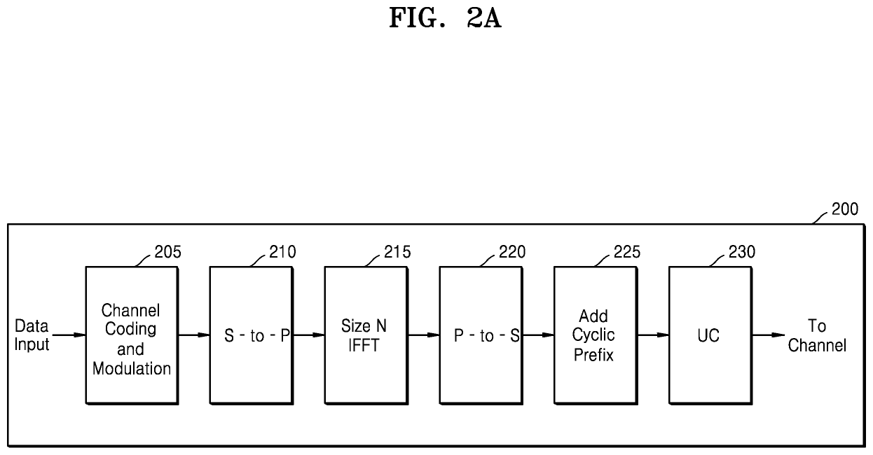

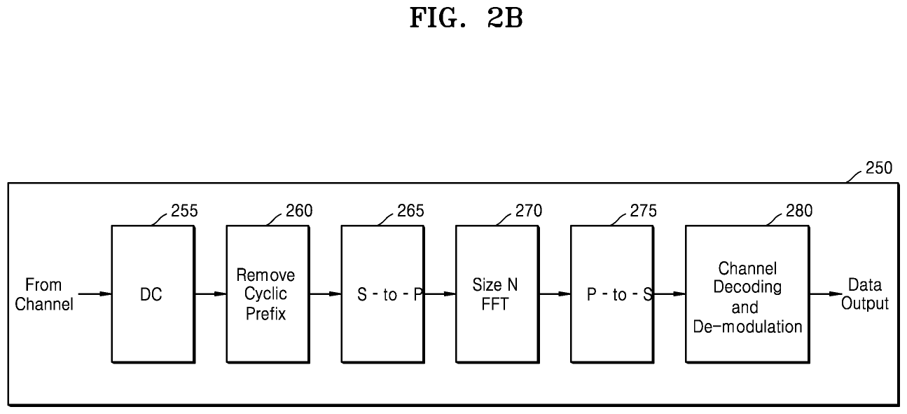

FIGS. 2A and 2B illustrate a wireless transmission and reception paths according to an embodiment of the disclosure. In the following description, the transmission path 200 can be described as being implemented in a gNB, such as gNB 102, and the reception path 250 can be described as being implemented in a UE, such as UE 116. However, The reception path 250 can be implemented in a gNB and the transmission path 200 can be implemented in a UE. In an embodiment, the reception path 250 is configured to support codebook designs and structures for systems with 2D antenna arrays as described in embodiments of the disclosure.

The transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230. The reception path 250 includes a down-converter (DC) 255, a cyclic prefix removal block 260, a serial-to-parallel (S-to-P) block 265, a size N fast Fourier transform (FFT) block 270, a parallel-to-serial (P-to-S) block 275, and a channel decoding and demodulation block 280.

In the transmission path 200, the channel coding and modulation block 205 receives a set of information bits, applies coding (such as low density parity Check (LDPC) coding), and modulates the input bits (such as using quadrature phase shift keying (QPSK) or quadrature amplitude modulation (QAM)) to generate a sequence of frequency-domain modulated symbols. The serial-to-parallel (S-to-P) block 210 converts (such as demultiplexes) serial modulated symbols into parallel data to generate N parallel symbol streams, where N is a size of the IFFT/FFT used in the gNB 102 and the UE 116. The size N IFFT block 215 performs IFFT operations on the N parallel symbol streams to generate a time-domain output signal. The parallel-to-serial block 220 converts (such as multiplexes) parallel time-domain output symbols from the size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from the gNB 102 arrives at the UE 116 after passing through the wireless channel, and operations in reverse to those at the gNB 102 are performed at the UE 116. The down-converter (DC) 255 down-converts the received signal to a baseband frequency, and the cyclic prefix removal block 260 removes the cyclic prefix to generate a serial time-domain baseband signal. The serial-to-parallel block 265 converts the time-domain baseband signal into a parallel time-domain signal. The size N FFT block 270 performs an FFT algorithm to generate N parallel frequency-domain signals. The parallel-to-serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from the gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as discrete Fourier transform (DFT) and inverse discrete Fourier transform (IDFT) functions. For DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate an example of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

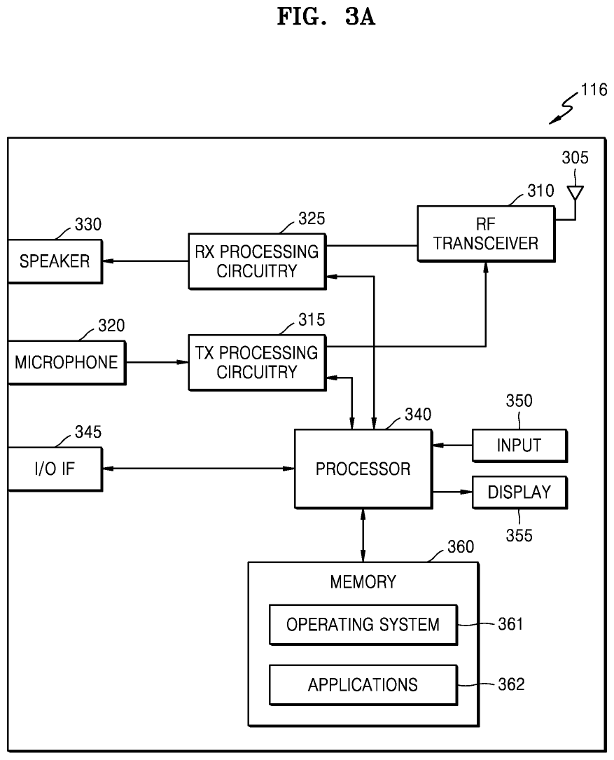

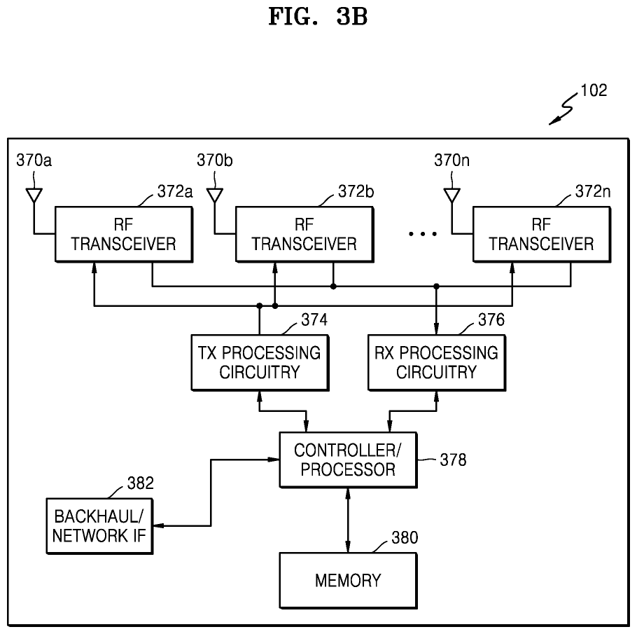

FIG. 3A illustrates an UE 116 according to an embodiment of the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

The UE 116 includes an antenna 305, a radio frequency (RF) transceiver 310, a transmission (TX) processing circuit 315, a microphone 320, and a reception (RX) processing circuit 325. The UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In an embodiment, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In an embodiment, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into the UE 116 using the input device(s) 350. The display 355 may be a liquid crystal display (LCD) or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to an embodiment of the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. The gNB 101 and the gNB 103 can include the same or similar structures as the gNB 102.

As shown in FIG. 3B, the gNB 102 includes a plurality of antennas 370a-370n, a plurality of RF transceivers 372a-372n, a transmission (TX) processing circuit 374, and a reception (RX) processing circuit 376. In an embodiment, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In an embodiment, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in an embodiment of the disclosure. In an embodiment, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows the gNB 102 to communicate with other devices or systems through a backhaul connection or through a network. The backhaul or network interface 382 can support communication over any suitable wired or wireless connection(s). For example, when the gNB 102 is implemented as a part of a cellular communication system, such as a cellular communication system supporting 5G or new radio access technology or NR, LTE or LTE-A, the backhaul or network interface 382 can allow the gNB 102 to communicate with other gNBs through wired or wireless backhaul connections. When the gNB 102 is implemented as an access point, the backhaul or network interface 382 can allow the gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, the gNB 102 can include multiple instances of each (such as one for each RF transceiver).

It can be understood by those skilled in the art that “terminal” and “terminal device” used herein include both a device of wireless signal receiver, which only has a device of wireless signal receiver without transmission capability, and a hardware device for receiving and transmitting, which has a hardware device capable of receiving and transmitting of bidirectional communication on a bidirectional communication link. Such devices may include a cellular or other communication device having a single-line display or a multi-line display or a cellular or other communication device without a multi-line display; personal communication system (PCS), which may combine voice, data processing, fax and/or data communication capabilities; personal digital assistant (PDS), which may include a RF receiver, pager, Internet/Intranet access, web browser, notepad, calendar and/or global positioning system (GPS) receiver; a conventional laptop and/or palmtop computer or other device having and/or including a radio frequency receiver. As used herein, “terminal” and “terminal device” may be portable, transportable, installed in vehicles (air, sea and/or land), or suitable and/or configured to operate locally, and/or operate in any other position on the earth and/or space in a distributed form. The “terminal” and “terminal device” used here may also be communication terminals, internet terminals, music/video playing terminals, such as PDA, mobile internet device (MID) and/or mobile phones with music/video playing function, as well as smart TVs, set-top boxes and other devices.

Recently, artificial intelligence (AI) technology represented by deep learning algorithm has risen again, which has solved the problems that have existed in various industries for many years and achieved great technical and commercial success. With the continuous evolution of wireless communication systems, those problems existed in air interface have been studied and tried to introduce new methods to solve them. In recent years, many air interface related problems of wireless communication have been widely studied based on solutions of AI technology, resulting some results superior to traditional algorithms in theory. In the standardization discussion of the upcoming Rel-18 release of 3GPP, the standardization organization of 5G NR, the physical layer wireless communication technology based on AI has also been widely discussed, and it is possible to be included into the standards of 5G and/or 6G wireless communication technology in the future.

In order to solve some problems encountered in communication, a machine learning method may be enabled. The machine learning method usually refers to the algorithm design of machine learning and the machine learning model design on which the algorithm is based. For a machine learning algorithm, it is usually divided into two different stages, namely, a training stage and an inference stage. Generally, the machine learning model may first go through the training stage, that is, learning weights of parameters in the machine learning model according to task objectives. At this time, data provided for training may be obtained online or offline; after the training is completed, the machine learning model may be used in the inference stage, that is, tasks such as optimization, prediction, classification and regression, etc., are performed according to the results of model training. These two stages may be performed separately and independently, or alternatively.

The solution based on AI deep learning (DL) technology usually involves the algorithm of AI model in machine learning technology, such as artificial neural network. The model of deep learning network is usually composed of artificial neural networks with multiple layers stacked. By training the existing data, the weight parameters in the neural network are adjusted, and then they are used to achieve the task goal in the inference stage in an unencountered case. Generally, compared with a general solution or algorithm based on fixed rules, the solution based on DL needs better computing power than the original classical algorithm, which usually requires a special computing chip in the device running DL algorithm to support the more efficient operation of DL algorithm.

Using AI algorithm based on machine learning to solve communication problems usually needs to meet the conditions of machine learning problems. Among the problems related to air interface in communication, many problems, such as channel information feedback, reference signal estimation, beamforming, user equipment positioning, etc., meet the conditions to some extent, so machine learning algorithm can be used to solve them, and better results can be achieved than traditional solutions in the process of communication transmission.

Herein, the term “machine learning algorithm/model” can be used with AI (artificial intelligence)/ML (machine learning) based technology, AI/ML for NR air interface, AI/ML technology, AI/ML architecture, AI/ML model, AI/ML for air interface, AI/ML method, AI/ML related algorithm, AI/ML based algorithm, and AI/ML scheme interchangeably.

In communication systems (e.g., NR systems), a base station may perform beam management based on a feedback result of a UE for reference signal measurement. Generally, measurements are made based on reference signals such as synchronization signal/physical broadcast channel (SS/PBCH) blocks (SSBs) or channel state information reference signals (CSI-RSs) for channel state information, etc. However, in order to select an optimal beam among all beams, the base station needs to transmit reference signals for measuring each beam to the UE. This will bring resource overhead and waste the power consumption of UE to measure the reference signal of each beam. Therefore, it is necessary to provide a reference signal/beam management method to reduce resource overhead and power consumption of the UE.

In order to solve at least one of the above problems, an embodiment of the disclosure provides a beam/reference signal management method. For example, beams/reference signals for measurement and/or reporting can be managed based on an AI model.

In order to solve at least one of the above problems, an embodiment of the disclosure provides a reference signal measurement method. For example, a measurement of a reference signal may be performed based on an AI model.

In some embodiments, a beam may refer to a signal that can be formed by precoding with beamforming information. Different beamforming weight sets may be applied to each reference signal resource to generate different directional beams for each reference signal resource. In an embodiment, each reference signal resource may identify quasi-co-located (QCL) and/or transmission control information (TCI) state information of a transmit (Tx) beam. In NR protocols, the beam is not specified and directly indicated. In NR, a QCL type of one or two downlink reference signals is indicated by a TCI-State.

In an example, the UE may be configured with QCL information and/or TCI information of a reference signal or a resource of the reference signal. The QCL information may indicate QCL assumptions of one or more types of reference signals and channels associated with different cell identities (IDs) (e.g., corresponding to different transmission and reception points (TRPs)). QCL assumptions are generally defined in the form of channel attributes. For example, the QCL assumptions can be defined as follows: “If attributes of a channel on which symbols on one antenna port are communicated can be inferred from a channel on which symbols on another antenna port are communicated, the two antenna ports are said to be QCLed.” If the receiver (e.g., UE) can apply channel attributes determined by detecting a first reference signal to help detect a second reference signal, the different reference signals can be regarded as QCLed. A TCI state generally includes configurations such as a QCL relationship (for example, a QCL relationship between DL RS(s) and DMRS ports of a PDSCH in a CSI-RS set).

For example, the quasi-co-located (QCL) type indicated to the UE may be based on a higher layer parameter QCL-Type, and may adopt one or a combination of the following types:
“typeA”: {Doppler shift, Doppler spread, average delay, delay spread};
“typeB”: {Doppler shift, Doppler spread};
“typeC”: {Doppler shift, average delay}; and
“typeD”: {Doppler shift, spatial receive (Rx) parameter}.

In an embodiment, for measurement (e.g., layer 1(L1)-reference signal received power (RSRP) computation): When resource-wise QCL types are predetermined types (e.g., QCL typeC and QCL typeD), the UE may be configured with CSI-RS resources, SS/PBCH block resources, or both CSI-RS and SS/PBCH block resources; or, for example, the UE may be configured with CSI-RS resource settings up to 16 CSI-RS resource sets having up to 64 resources within each set. For example, the total number of different CSI-RS resources over all resource sets is no more than 128. Among them, a non-zero-power (NZP) CSI-RS or SSB can be referred to as a TCI source, which is used to indicate TCI state. For example, by associating a TCI state ID with an ID of a CSI-RS or SSB, a downlink channel configured with the TCI state ID is associated with the CSI-RS or SSB. This association can be understood as that the downlink transmission uses the same beam (such as QCL typeD) as the downlink transmit beam. Similarly, a beam for uplink transmission may also be specified by an uplink transmit beam in a similar way.

The existing L1-RSRP report may be configured with reporting of at most 4 measurement results by higher-layer. If only one value of a L1-RSRP is to be reported, then this value is reported by 7 bits in the range of [−140,−44]dB with 1 dB step size. If the higher-layer configures more than one measurement result to be reported, the UE may report a difference with the best L1-RSRP, and report the difference with best L1-RSRP by 4 bits with 2 dB step size.

As mentioned above, the reference signal, the resource of the reference signal and the beam are associated with each other. Performing measurement on a beam may mean measuring a reference signal transmitted through a beam. When measuring a specific transmit beam or a reference signal that can be transmitted by using this beam, a terminal may use different receive antennas (or beams) to perform receiving measurement, and calculate measurement results that need to be reported. Different measurement results may be obtained when the UE uses different receive antennas (or beams) for measurement. Such a “pair” consisting of a transmit beam and a receive beam is called a “beam pair.” A serial number (ID) can be specified for a “beam pair,” or a “beam pair” may be indicated by a combination of an ID of the transmission antenna (or beam) and an ID of the receive antenna (or beam) corresponding to the “beam pair.” Therefore, in embodiments of the disclosure, unless otherwise indicated, the terms “beam,” “beam pair,” “reference signal” and “resources of a reference signal” may be used interchangeably. Therefore, a measurement result of a reference signal may also indicate a measurement result of a corresponding beam.

In some embodiments of the disclosure, a measurement result of a transmit beam or a reference signal may be obtained through the measurement of a specific receive beam. Or the measurement result is an optimal measurement result among the measurement results obtained by adopting all the receive beams. Or the measurement result may refer to a set of measurement results of a plurality of receive beams to a transmit beam or a reference signal.

When a good (e.g., optimal) beam is determined from one or more beams, the measurement result of the good (e.g., optimal) beam may be superior to other beams in the one or more beams. Or the measurement result of the good (e.g., optimal) beam is higher than a predetermined threshold. For example, there may be multiple good (e.g., optimal) beams whose measurement results are superior to other beams in the one or more beams. Therefore, in an embodiment of the disclosure, “optimal” or “good” may not mean that there is only one optimal beam, but there may be at least one optimal beam.

In an embodiment of the disclosure, a measurement result (for example, a measurement result of a reference signal or a beam) may include at least one of the following: a L1-RSRP, a signal to interference plus noise ratio (SINR), a signal to noise ratio (SNR), a difference between the L1-RSRP and a L1-RSRP of an optimal beam, or a difference between the value of the L1-RSRP and a target value. The measurement results may also include other channel state information.

The types of AI models related to various embodiments of the disclosure may include at least one of the following: perceptron, feedforward neural network, radial basis function network, deep feedforward network, recurrent neural network, long/short term memory network, gated recurrent unit, automatic encoder, variational automatic encoder, denoised automatic encoder, sparse automatic encoder, Markov chain, Hoffett network, Pozmann machine, restricted Pozmann machine, deep belief network, deep convolutional network, deconvolutional neural network, deep convolutional inverse graph network, generative adversarial network, liquid machine, extreme learning machine, echo state network, deep residual network, Kohonen network, support vector machine, neural Turing machine, convolutional neural network, artificial neural network, deep neural network, etc. Any suitable training method may be used to train an AI model, such as supervised training and unsupervised training, etc.

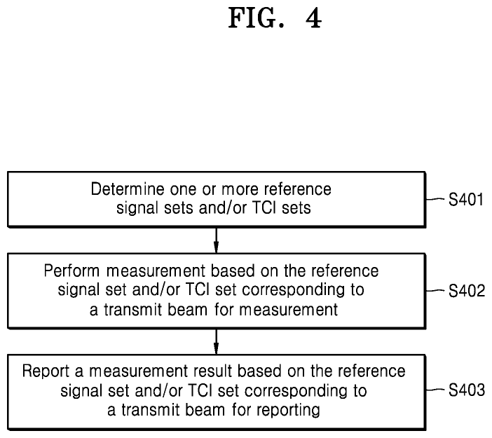

FIG. 4 illustrates a flowchart of a method performed by a UE in a communication system according to an embodiment of the present disclosure. Although the method including steps S401-S403 is shown in FIG. 4, some steps may be omitted and additional steps may be included.

Referring to FIG. 4, in Step S401, the UE identifies one or more reference signal sets and/or TCI sets. For example, the one or more reference signal sets and/or TCI sets may include at least one of the following: a reference signal set SET_A1 and/or a TCI set SET_A2 corresponding to potential transmit beams, a reference signal set SET_B1 and/or a TCI set SET_B2 corresponding to transmit beams for measurement (e.g., for measurement of quantities of reference signals such as L1-RSRP etc.), or a reference signal set SET_C1 and/or a TCI set SET_C2 corresponding to transmit beams for reporting (e.g., for reporting measurement results). For convenience of description, considering the association between the reference signal and the TCI, the set SETA is used to indicate the reference signal set SET_A1 and/or TCI set SET_A1, the set SET_B (also called measurement set SET_B) is used to indicate the reference signal set SET_B1 and/or TCI set SET_B1, and the set SET_C (also called reporting set SET_C) is used to indicate the reference signal set SET_C1 and/or TCI set SET_C1.

In an embodiment, considering the association of the reference signal, the TCI and the beam, the set SETA may also be used to indicate the set of potential transmit beams, the set SET_B may also be used to indicate the set of transmit beams for measurement, and the set SET_C may also be used to indicate the set of transmit beams for reporting.

In Step S402, the UE performs measurement based on the reference signal set SET_B1 and/or TCI set SET_B2 corresponding to the transmit beams for measurement.

In Step S403, the UE reports a measurement result based on the reference signal set SET_C1 and/or TCI set SET_C2 corresponding to the transmit beams for reporting.

In some examples, the reference signal set SET_B1 and/or TCI set SET_B2 corresponding to the transmit beams for measurement and the reference signal set SET_C1 and/or TCI set SET_C2 corresponding to the transmit beams for reporting may be the same.

In some examples, the set of transmit beams and/or set of beam pairs for measurement may be the same as or different from the set of transmit beams and/or set of beam pairs for reporting.

In some examples, the set SET_B (i.e., the reference signal set SET_B1 and/or TCI set SET_B2 corresponding to the transmit beams for measurement) may be a subset of the set SETA (i.e., the reference signal set SET_A1 and/or TCI set SET_A2 corresponding to the potential transmit beams). Or the set SET_B is a set different from the set SETA. For example, a transmit beam corresponding to the set SET_B is a wide transmit beam (which may be simply called a wide beam), while a transmit beam corresponding to the set SETA is a narrow transmit beam (which may be simply called a narrow beam). Or the set SET_B includes elements in the set SETA. For example, the set SET_B includes a wide beam and a narrow beam, where the narrow beam is included in the set SETA. The beams corresponding to the set SETA (i.e., potential transmit beams) may be the full set of beams on which a base station can perform transmission, or a subset of the full set of beams on which the base station can perform transmission. For example, when there are some wide beams and some narrow beams that can be transmitted by the base station, the beams corresponding to the set SETA may be all narrow beams, or all wide beams and narrow beams, or all wide beams in the full set of beams.

In some examples, information on the potential transmit beams may be preconfigured or predefined, or may be configured by the base station. In the the disclosure, the meaning of preconfiguring certain information or parameters in the UE can be interpreted as default information or parameters embedded in the UE when manufacturing the UE, or information or parameters pre-acquired and stored in the UE through higher layer signaling (for example, RRC) configuration, or information or parameters acquired and stored from the base station.

For example, the full set of beams (e.g., the set SETA corresponding to potential transmit beams) may be up to implementations. For the base station, this set is a set of all physically realizable beams. Each beam may have a corresponding reference signal (SSB or CSI-RS). In an example, the SSB may use a wide beam, while the CSI-RS may use a narrow beam. In embodiments of the disclosure, the terms “wide beam” and “narrow beam” are relative concepts, which may be up to implementations of the base station. For example, a wide beam may have a wider beam width than a narrow beam.

In existing NR systems, a transmit beam finally used by a base station for transmission may correspond to a TCI of a known SSB or NZP-CSI-RS. There may be no situation where the base station adopts a TCI set corresponding to a reference signal that is not configured for a UE for measurement. In embodiments of the disclosure, a beam (which may be identified, characterized or distinguished by TCI) used by the base station to perform downlink transmission (for example, to transmit reference signals) may not be in a set SET_B for UE measurement. For example, the set of downlink beams that may be adopted by the base station may be a set SETA.

In the following description, the embodiments of the disclosure may be described with respect to transmit beams. However, the embodiments of the disclosure are not limited to thereto. For example, the method described with respect to transmit beams in the embodiments of the disclosure is also applicable to determination of receive beams or transmit-receive beam pair (a beam pair of one transmit beam and one receive beam). For example, one or more optimal receive beams are determined according to measurement results of a set of receive beams for measurement, where the optimal receive beams may not belong to the beam set for measurement. Or one or more optimal beam pairs are determined according to measurement results of a set of beam pairs for measurement, where the optimal beam pairs may not belong to the set of beam pairs for measurement. In addition, the method described with respect to transmit beams in the embodiments of the disclosure is also applicable to the prediction of uplink transmission related beams and beam pairs by the base station or UE. For an uplink beam, sounding resource indicator (SRI) or uplink TCI is usually used to characterize beam information.

For the sake of simplicity, the following description adopts a set related to transmit beams.

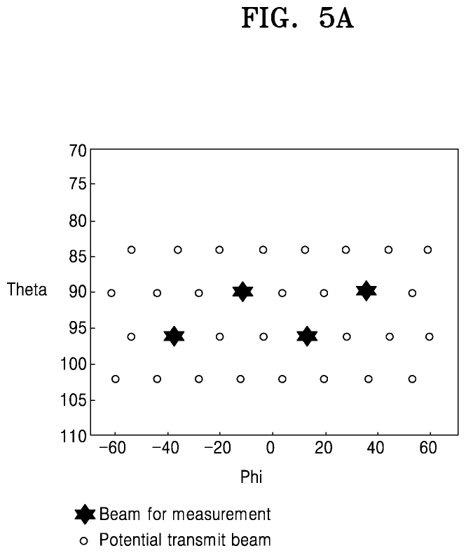

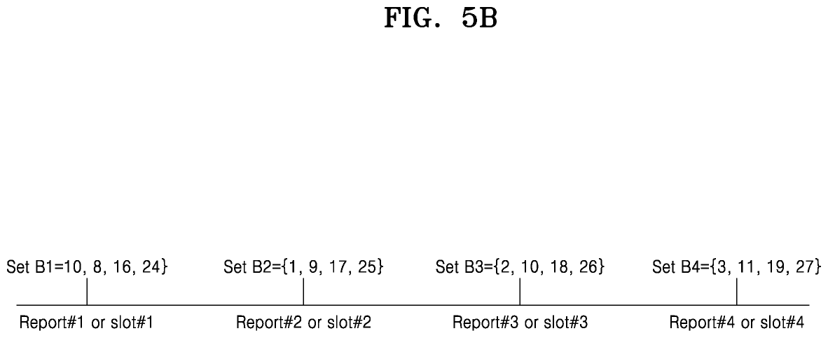

An example of determination (of set SET_B) in Step S401 is described below with reference to FIG. 5A.

FIG. 5A illustrates a schematic diagram of a set of beams for measurement (set SET_B) and a set of potential transmit beams (set SETA) according to an embodiment of the present disclosure. It should be noted that the number of beams shown in FIG. 5A is only an example. In FIG. 5A, the abscissa Phi and the ordinate Theta are two parameters in a spatial polar coordinate system.

As shown in FIG. 5A, the potential transmit beams are 4×8=32 beams. A reference signal set SET_A1 and/or TCI set corresponding to the potential transmit beams is the set SETA. A reference signal set SET_B1 and/or TCI set used for UE measurement is the set SET_B. In FIG. 5A, the set SET_B includes 4 beams.

According to an embodiment of the disclosure, the set SET_B for UE measurement (for example, the reference signal set SET_B1 and/or the TCI set SET_B2) may be determined or obtained based on one or more of the following methods.

Method 1-1: The base station may directly configure the set SET_B to the UE.

For example, the base station may directly configure the set SET_B for UE measurement to the UE through a combination of one or more of RRC, MAC or DCI. For example, the base station configures one or more sets SET_B that may be used for measurement to the UE by RRC, and dynamically indicates one of the one or more sets SET_B through MAC or DCI.

In addition, if the base station configures multiple sets SET_B to the UE, it may be predefined or configured to the UE that all the sets SET_B need to be measured.

The base station may select the set SET_B according to experience and configure the set SET_B to the UE. For example, the base station may select the set SET_B according to experience information of the UE or one or more other UEs.

As shown in FIG. 5B, the base station may configure multiple sets SET_B to the UE, such as Set B1={0, 8, 16, 24}, Set B2={1, 9, 17, 25}, Set B3={2, 10, 18, 26} and Set B4={3, 11, 19, 27}. Further, the base station may configure the UE with time and/or position information that needs to be measured and/or reported for each SET_B set. For example, the base station configures the UE to report a measurement result of Set B1 with Report #1, report a measurement result of Set B2 with Report #2, report a measurement result of Set B3 with Report #3 and report a measurement result of Set B4 with Report #4. For another example, the base station configures the UE with time domain position information of reference signals for measuring beams of Set B1-Set B4. For example, the time domain information (or position information of a group of periodic CSI-RSs), such as information for calculating at least one position information of frames, slots, or symbols, is directly configured for each measurement set SET_B.

In an embodiment, periods for the measurement sets may be configured, and Set B1-Set B4 are measured respectively in each period, and the measurements are reported. For example, the base station configures a group of periodic CSI-RSs to the UE, and measures Set B1, Set B2, Set B3 and Set B4 in a configured order in each period, respectively. Further, the measurement results of Set B1, Set B2, Set B3 and Set B4 may be reported in the reports corresponding to each group of CSI-RSs, respectively. In addition, the measurement results of Set B1, Set B2, Set B3 and Set B4 may also be reported together in one report. The format of reporting may be fixed. For example, each measurement result reported in a predefined or configured order corresponds to each set of SET_B, such as reporting {{L1-RSRP B1-1, L1-RSRP_B1-2, L1-RSRP_B1-3, L1-RSRP_B1-4}; {L1-RSRP_B2-1, L1-RSRP_B2-2, L1-RSRP_B2-3, L1-RSRP_B2-4}; {L1-RSRP_B3-1, L1-RSRP_B3-2, L1-RSRP_B3-3, L1-RSRP_B3-4}; {L1-RSRP_B4-1, L1-RSRP_B4-2, L1-RSRP_B4-3, L1-RSRP_B4-4}1. According to the predefined order, the base station may obtain the corresponding measurement results. For another example, information of SET_B and/or timestamp information corresponding to the measurement are simultaneously reported in the reporting information. For example, {{Set B1}{L1-RSRP_B1-1, L1-RSRP_B1-2, L1-RSRP_B1-3, L1-RSRP_B1-4}; {Set B3}{L1-RSRP_B3-1, L1-RSRP_B3-2, L1-RSRP_B3-3, L1-RSRP_B3-4} are reported.

For example, {{Slot1}{L1-RSRP_B1-1, L1-RSRP_B1-2, L1-RSRP_B1-3, L1-RSRP_B1-4}; {Slot3}{L1-RSRP_B3-1, L1-RSRP_B3-2, L1-RSRP_B3-3, L1-RSRP_B3-4}} are reported. Among them, Slot1 and Slot3 are time information corresponding to Set B1 and Set B3, respectively. For example, Slot1 and Slot3 may be slot indexes, frame indexes or symbol indexes. Slot1 or Slot3 may also be a time offset, such as a number of slots or a number of frames or a number of symbols, or an absolute time (such as milliseconds), etc. from a reference position. For the need of measurement and/or reporting, the base station may configure the above time-related information to the UE.

The method may obtain measurement results of different beams and improve the estimation performance.

Method 1-2: The UE may determine the set SET_B according to a pre-specified or configured criteria.

As an example, SSB(s) can be taken as the set for reference signal measurements, that is, the set SET_B. As an example, the base station may configure the UE with the set SETA of potential transmit beams that can be used for transmission, and/or the reference signal set SET_A1/TCI set SET_A2 related to the potential transmit beams. A number of elements in the set SET_B may be predetermined or configured to the UE, and the set SET_B may be determined according to the number of elements in the set SET_B and the set SETA. As an example, the set SETA may be down-sampled in spatial domain according to a predetermined rule to obtain the set SET_B. For example, the UE may select the set SET_B from the set SETA according to a number of elements in the set SETA and the set SET_B, for example, by a means of reducing the dimension of the set SETA. In an example described in connection with FIG. 5, since the set SET_A has 32 beams and the set SET_B has 4 beams, in the set SET_A, one beam is selected every 8 beams as an element in the set SET_B.

The UE may determine the set SET_B according to a TCI relationship. For example, the UE may select one or a fixed number of beams for each of TCIs corresponding to the beams in the set SET_A to construct the set SET_B.

For example, the base station may configure multiple sets SET_B that may be used for measurement to the UE, and the UE selects one or more of them as the set SET_B for measurement based on a predefined criteria. For example, the UE may randomly select one or more of them as the set SET_B for measurement. Or the UE determines one or more sets as the set SET_B for measurement according to slots (or other time units).

Method 1-3: The UE can autonomously select the set SET_B for measurement.

The UE can autonomously determine the set SET_B according to the set SETA of potential transmit beams of the base station or the reference signal set SET_A1/TCI set SET_A2 corresponding to the potential transmit beams. Method 1-2 is that the UE makes a selection according to a predefined or configured rule. Method 3 may make an autonomous selection according to an algorithm of the UE. For example, the UE may select an appropriate receive beam for measurement according to previous information or experience, and thus determine the set SET_B for measurement.

According to an embodiment of the disclosure, the UE may determine the measurement set SET_B by using an AI model.

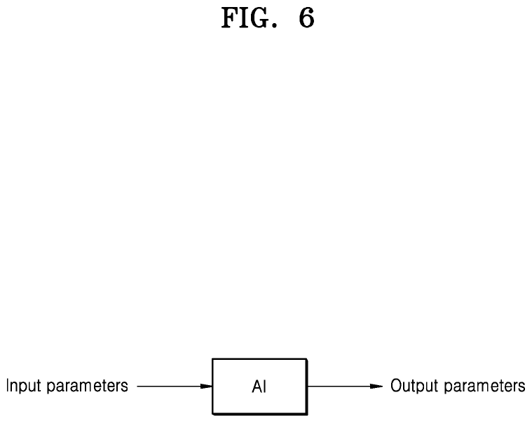

As shown in FIG. 6, the AI model may be trained to output the measurement set SET_B or its related information based on input parameters.

In some examples, the input parameters of the AI model may include at least one of the following: transmit beam related information, historical measurement results and related measurement beam information. Output parameter of the AI model may be the measurement set SET_B. For example, a number (size) of elements of the measurement set SET_B may be obtained through a configuration by the base station. The AI model may be obtained by autonomous training by the UE, or may be obtained by signaling from another device (for example, a base station or a server). Particularly, all or part of the information of the AI model, such as parameters of the AI model, may be obtained through signaling. The related measurement beam information may be at least one of a transmit beam ID, a receive beam ID and a beam pair ID corresponding to a measurement.

In an embodiment, the input parameters of the AI model may also include at least one of the following: potential transmit beam information, UE location information, UE speed information, UE moving direction, receive beam information, UE rotating direction, or UE receiving angle. In an example, the potential transmit beam information may include at least one of the following: an identity (ID) of a potential transmit beam, a beam book of the potential transmit beam, a structure of the potential transmit beam (in the example shown in FIG. 5, the structure of the potential transmit beam is a 4×8 matrix), angle information of the potential transmit beam, a departure angle of the potential transmit beam, a width of the potential transmit beam, etc.

For example, the input of the AI model may include a matrix (beam IDs) characterizing the beam structure, such as the following 4×8 matrix M1 (each element in the matrix M1 represents a beam ID):
{0,1,2,3,4,5,6,7 8,9,10,11,12,13,14,15 16,17,18,19,20,21,22,23, 24,25,26,27,28,29,30,31}.

For example, the input of the AI model may include the measurement results related to the beam structure, such as the following 4×8 matrix M2 (each element in the matrix M2 represents measurement results of corresponding beams (corresponding to respective elements in the matrix M1)):
{NA, NA, NA, NA, NA, −98.1, NA, NA,
NA, NA, −103, NA, NA, NA, NA, NA,
NA, NA, NA, NA, −99, NA, NA, NA,
NA, NA, NA, NA, NA, NA, NA, −105}.

In the above matrix, ‘NA’ indicates that there is no corresponding measurement result, and −98.1, −103, −99 and 105 indicate the measurement results of beams corresponding to the corresponding matrix positions, respectively, and is in units of dB.

M1 and/or M2 described above may also be a one-dimensional matrix.

Furthermore, information related to time corresponding to the measurement may be input to the AI model. For example, two 4×8 matrices may be input, representing the measurements at two different times T1 and T2, respectively. Or a higher-dimensional (for example, the dimension is greater than or equal to 3) matrix may be used to represent the measurements at different times. For example, a matrix of a dimension of 2×4×8 is input, which represents the measurements (characterized by a dimension of 4×8) at two different times T1 and T2. The time information T1 and T2 may be characterized in an implicit way. For example, it is specified in advance that each matrix represents the measurement results at two times with an interval of (T2−T1). N matrices may be used to represent the measurement results at N number of times with N−1 equal intervals, respectively. Or the measurement time may also be directly used as the input of the AI model.

In an example, the measurement results or measurements may include at least one of the following: a L1-RSRP, a SINR, a SNR, a difference between the L1-RSRP and an optimal L1-RSRP, a difference between the L1-RSRP and a target value, a value of the L1-RSRP quantized with a predefined criteria, etc.

For example, the beam book set of transmit beams is a horizontal angle and a vertical angle corresponding to each transmit beam.

A similar method may be used to construct an associated matrix for other information as input.

In an example, the receive beam information may include at least one of the following: an ID of a receive beam, a beam book of the receive beam, a structure of the receive beam, angle information of the receive beam, a departure angle of the receive beam, and/or the like.

In an example, the output of the AI model may be the set SET_B with an optimal measurement result (e.g., with an optimal transmit beam).

In addition, due to the change of a channel or the change of a UE location, the optimal measurement set SET_B used at different times may be different. For example, a set containing an optimal beam may change after 10 ms and 50 ms for a high-speed train running at a high speed. In the AI model, the time information corresponding to the measurement set SET_B can be further input. For example, time information 10 represents the measurement set SET_B predicted for 10 ms later, and time information 50 represents the measurement set SET_B predicted for 50 ms later.

It is described above that the UE determines the measurement set SET_B by using an AI model. Additionally or alternatively, the base station may obtain the set SET_B by using an AI model through a similar method, and configure the set SET_B for measurement to the UE (as in the above method 1-1).

In NR systems, an SSB may be transmitted with a wide beam (also called a wide transmit beam in the embodiments of the disclosure). Because the SSB is a broadcast channel, it is expected that the SSB can cover a large range. However, after RRC establishment, the SINR of a receiving end can be improved by adopting a narrow beam (also called a narrow transmit beam in the embodiments of the disclosure), thereby improving the throughput. Generally, a UE may measure a reference signal (for example, SSB or CSI-RS, such as a tracking reference signal (TRS)) in an IDLE state. After the base station establishes a link with the UE, the UE may report measurement results of the reference signal (for example, SSB) to the base station. Before the CSI-RS transmitted through the narrow beam is configured to the UE, a prediction may be made according to the report of the wide beam by the UE for selection of an optimal narrow beam. Generally, there is a certain relationship between a narrow beam and a wide beam. For example, one or more narrow beams may be covered by a wide beam. That is, a wide beam may include one or more narrow beams or be associated with the one or more narrow beams.

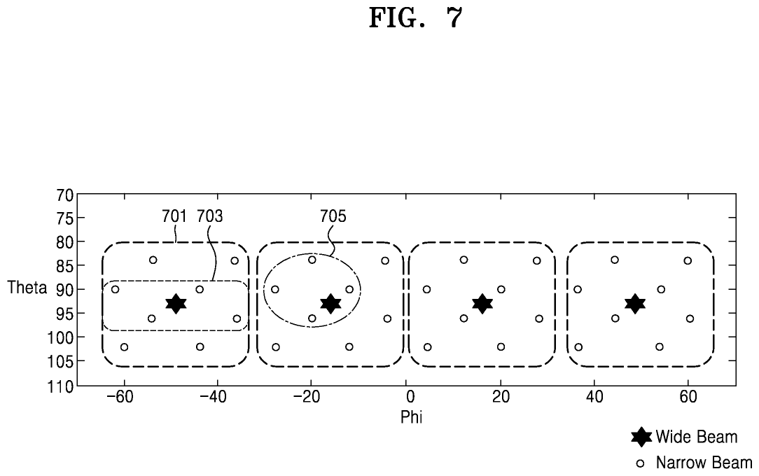

FIG. 7 illustrates a schematic diagram of a relationship between a wide beam and a narrow beam according to an embodiment of the present disclosure. It should be noted that the number and arrangement of beams shown in FIG. 7 are only examples, and there may be more or less wide beams or more or less narrow beams. In FIG. 7, the abscissa Phi and the ordinate Theta are two parameters in a spatial polar coordinate system.

As shown in FIG. 7, there are 4 wide beams and 32 narrow beams. For example, it may be considered that the 8 narrow beams 701 closest to a wide beam are covered by the wide beam. The UE can measure and/or report 4 wide beams. The UE or the base station may select 4 narrow beams corresponding to an optimal beam among the 4 wide beams as the beam set SET_B for measurement. The UE can further measure the narrow beams in the set SET_B, so as to predict or obtain an optimal downlink transmit beam. Or the base station may configure the UE with a narrow beam corresponding to an optimal wide beam for further measurement.

The above method can be implemented by the base station or the UE. For example, a beam for measurement may be selected based on at least one of the following methods.

Method 2-1: Select M beams corresponding to an optimal wide beam.

In an example, for each of wide beams, several corresponding narrow beams may be predefined or configured, so that the wide beams have a corresponding relationship with the narrow beams. As shown in FIG. 7, a wide beam has a certain corresponding relationship with N=8 narrow beams (for example, the N=8 narrow beams are within a wide beam).

If the number M of beams in the measurement set SET_B is less than the number N of beams corresponding to the wide beam, Method 2-1-A or Method 2-1-B may be adopted.

Method 2-1-A: Randomly select M narrow beams N from the N narrow beams corresponding to the optimal wide beam as the set SET_B.

Method 2-1-B: Preferentially select specific N′ narrow beams among the N narrow beams corresponding to the optimal wide beam as the set SET_B.

With continued reference to FIG. 7, the 4 narrow beams 703 in FIG. 7 are the specific N′ (N′=4) narrow beams among the N (N=8) narrow beams. The 4 narrow beams 703 may be the most commonly used 4 narrow beams obtained based on experience, or the 4 narrow beams 703 closest to the center of the wide beam.

If a number of elements in the measurement set SET_B is less than or equal to N′, M narrow beams are selected from the specific N′ narrow beams. Among them, the selection may be made randomly or according to experience values.

If the number of elements in the measurement set SET_B is greater than N′, specific N′ narrow beams are selected as elements of the target set SET_B. Then, M-N′ narrow beams are selected from the N-N′ other narrow beams. For example, the selection may be made randomly or according to experience values. For example, assuming that the number of elements in the target set SET_B is M=5 and N′=4, all N′ beams are selected first, and then one beam is randomly selected from the other 4 beams to construct the target set SET_B with M=5 together with the N′ beams.

Method 2-2: Select the measurement set 705 SET_B by using an AI model.

For example, the input parameters of the AI model may include at least one of the following: measurements of the beams for measurement, potential transmit beam information, a relationship between the beams for measurement and the potential transmit beams, and related measurement beam information. Among them, the related measurement beam information may be at least one of a transmit beam ID, a receive beam ID and a beam pair ID corresponding to the measurement.
Measurements of the beams for measurement, for example, the measurements of all wide beams: which may be a measurement corresponding to a transmit beam (such as a value measured with an optimal receive beam or a specific receive beam), or a measurement corresponding to a beam pair. Particularly, in order to determine the measurement set SET_B suitable for a certain time Tf in the future, it is necessary to perform the same based on the measurements of the beams for measurement for one or more times Tn (n=1, 2, . . . f−1) in the past. For example, the measurements of the beams for measurement may include a measurement matrix: {−98.1, −99, −102, −105}. Further, time information corresponding to the measurements, for example, time Tn (n=1, 2, . . . f−1), may be input into the AI model. Or, the corresponding time information is implicitly represented by the input measurements, for example, the measurements at multiple times represented by multiple predefined matrices. For example, two matrices may be input to represent the measurements at two different times T1 and T2, respectively. Or the measurements at multiple times are represented by a higher-dimensional matrix. The measurements at different times may be represented by a higher-dimensional matrix (for example, the dimension is greater than or equal to 3). For example, a matrix of a dimension of 2×4×8 is input, which represents the measurements (characterized by a dimension of 4×8) at two different times T1 and T2. The time information T1 and T2 may be characterized in an implicit way. For example, it is specified in advance that each matrix represents the measurement results at two times with an interval of (T2-T1). N matrices may be used to represent the measurement results at N number of times with equal intervals, respectively.

For the above measurement results, if the measurement of the first beam (−98.1) and the measurement of the second beam (−99) are not far apart, then the optimal beam set is likely to be narrow beam(s) between the two beams. AI (Method 2-2) can infer such experience information through learning, thus obtaining better performance than Method 2-1. Compared with Method 2-2, Method 2-1 is simpler and has low implementation complexity.
Potential transmit beam information. For example, the potential transmit beam information may include at least one of the following: an ID of a potential transmit beam, a beam book of the potential transmit beam, a structure of the potential transmit beam (in the example shown in FIG. 5, structure of the potential transmit beam is a 4×8 matrix), a measurement matrix of the potential transmit beam, angle information of the potential transmit beam (for example, a departure angle of the potential transmit beam), and/or the like.

For example, the measurement matrix of the potential transmit beams may be a 4×8 matrix. The element of the measurement matrix may be NA, or 0, or other predetermined values.

If the potential transmit beams include all or part of the beams for measurement, the measurement matrix of the potential transmit beams may include the measurement results of all or part of the beams for measurement. For example, the measurement matrix of the potential transmit beams may be:
{NA, NA, NA, NA, NA, −98.1, NA, NA,
NA, NA, −103, NA, NA, NA, NA, NA,
NA, NA, NA, NA, −99, NA, NA, NA,
NA, NA, NA, NA, NA, NA, NA, −105}.

In the above matrix, ‘NA’ indicates that there is no corresponding measurement result, and −98.1, −103, −99, and 105 indicate the measurement results of beams corresponding to the matrix positions, respectively, and are in units of dB. Further, information related to time corresponding to the measurement may be input into the AI model, for example, time Tn (n=1, 2, . . . f−1). Alternatively, the corresponding time information is implicitly represented by the input measurements, for example, the measurements at multiple times represented by multiple predefined matrices. For example, two matrices may be input to represent the measurements at two different times T1 and T2, respectively. Or a higher-dimensional matrix is used to represent the measurements at multiple times, etc. The measurements at different times may be represented by a higher-dimensional matrix (for example, the dimension is greater than or equal to 3). For example, a matrix of a dimension of 2×4×8 is input, which represents the measurements (characterized by a dimension of 4×8) at two different times T1 and T2. The time information Ti and T2 may be characterized in an implicit way. For example, it is specified in advance that each matrix represents the measurement results at two times with an interval of (T2-T1). N matrices may be used to represent the measurement results at N number of times with equal intervals, respectively.
Relationship between the beams for measurement in the measurement set SET_B and the potential transmit beams in the SETA. It may be characterized in an implicit way. For example, it may be obtained by an implicit relationship between the structure (matrix) of the potential transmit beams and the measurements of the beams for measurement.

In an embodiment, the input of the AI model may include assistance information to improve inference performance of the AI. For example, the assistance information may include at least one of the following: UE location information, UE speed information, UE moving direction, receive beam information, UE rotating direction, UE receiving angle, UE-specific related information, such as UE moving speed, UE moving direction, UE receive antenna related information, etc.

The method of selecting beams for measurement described above may be performed by a UE or a base station.

If Method 2-2 is performed for AI inference at the UE side, the AI model may be trained by the UE, or may be transmitted to the UE through signaling after being trained by the base station (or other nodes).

Further, when the number of elements in the optimal measurement set in the above method is 1, it is equivalent to that the optimal beam (the unique optimal beam) is selected. This beam may be used for downlink transmission. If the above method is performed by the UE, the UE may report the optimal beam or the set of optimal beams to the base station.

If the above method is performed by the base station, the base station may configure a set of optimal beams to the UE for measurement according to the above measurement set SET_B. If a number of elements in the measurement set SET_B is 1, this beam is the predicted optimal beam. The base station may perform downlink transmission according to the optimal beam.

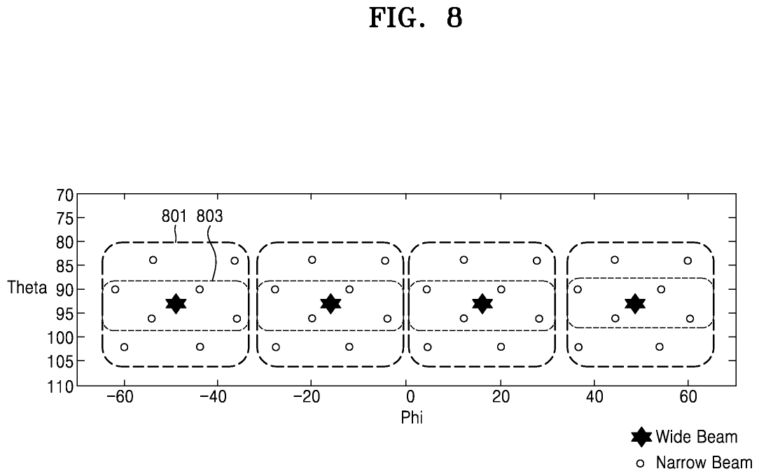

FIG. 8 illustrates a method for obtaining an optimal beam in a set of potential transmit beams based on a measurement set according to an embodiment of the present disclosure. It should be noted that the number and arrangement of beams shown in FIG. 8 are only examples, and there may be more or less wide beams or more or less narrow beams. In FIG. 8, the abscissa Phi and the ordinate Theta are two parameters in a spatial polar coordinate system.

For example, the measurement set SET_B may include several wide beams and several narrow beams. As shown in FIG. 8, the measurement set SET_B includes 4 wide beams and the 4 or 8 optimal narrow beams determined according to the measurement results of the 4 wide beams. For example, the UE first measures the 4 wide beams and some narrow beams related to one or more of the 4 optimal wide beams. For example, the relationship between narrow beams and wide beams may be predefined or configured. Or, as described in the previous Method 2-1 or 2-2, the narrow beam set for measurement may be predicted according to the measurement results of the wide beams.

As shown in FIG. 8, a wide beam is associated with 8 narrow beams 801 or 4 narrow beams 803 and each of other wide beam is associated with 8 or 4 narrow beams. After measuring 4 wide beams, UE selects several narrow beams related to the wide beams for measurement. For example, the measurement may be performed based on one or more of the following methods.

Method 3-1: Perform measurement on a wide beam set, and perform measurement on predefined narrow beam(s) according to measurement results of the wide beams. As shown in FIG. 8, the UE may measure 4 wide beams and measure 8 or 4 narrow beams related to the optimal wide beam for measurement. For example, the number of narrow beams (8 or 4) related to the wide beam may be preconfigured or calculated according to pre-defined rules.

Method 3-2: Measure a wide beam set, and randomly select a subset from the predefined narrow beams for measurement according to the measurement results of the wide beams. As shown in FIG. 8, the UE randomly selects some of measuring 4 wide beams and measuring 8 or 4 narrow beams related to the optimal wide beam for measurement. For example, one beam may be randomly selected for measurement. For example, the number (8 or 4) of narrow beams related to a wide beam may be preconfigured or calculated according to pre-defined rules.

Method 3-3: Perform measurement on a wide beam set, and select one or more narrow beams from predefined narrow beam(s) according to measurement time information of the narrow beams, based on the measurement results of the wide beams. As shown in FIG. 8, the UE measures 4 wide beams to obtain an optimal wide beam, and then measures 4 narrow beams related to the optimal wide beam. For example, one or more of 4 narrow beams, beam 0, beam 1, beam 2 and beam 3, may be measured respectively in a predefined or configured order at time t, t+1, t+2 and t+3. For example, each narrow beam is measured sequentially at each time. For example, one beam is randomly selected every 4 beams for measurement. For example, the number (8 or 4) of narrow beams related to a wide beam may be preconfigured or calculated according to pre-defined rules.

Further, the UE may determine one or more receive beams to perform the above measurement according to autonomous implementation, according to a predefined method, or according to a configuration by the base station.

In some examples, the measured results based on the above methods may be used for training AI models (for example, one or more of the AI models described in the embodiments of the disclosure) and/or as input of the trained AI models to obtain the optimal beam.

In some examples, the input of the AI model may include at least one of the following: measurement results, measurement beam related information, potential optimal beam set related information, UE location information, UE speed information, UE moving direction, receive beam information, UE rotation direction, and UE receive angle.

For example, the potential optimal beam set related information includes at least one of the following: a set of IDs of potential optimal beams, a beam book of an optimal beam, a structure of the optimal beam (for example, as shown in FIG. 8, the structure of the potential transmit beam is a 4×8 matrix), angle information of the potential optimal beam, and/or the like.

Among them, the optimal beam set related information may be transmit beam set related information, or receive beam set related information and beam pair related information.

The optimal transmit beam may be obtained by beam sweeping of receive beams, or may be obtained by sweeping of transmit beams in a measurement set with a specific receive beam. The specific receive beam may be selected by the UE autonomously (such as according to historical information, or the result of the AI model for selecting the optimal measurement beam, etc.) or implemented according to a configuration by the base station.

For example, the input of the AI model may include a matrix (beam IDs) characterizing the beam structure, such as the following 4×8 matrix:
{0,1,2,3,4,5,6,7
8,9,10,11,12,13,14,15
16,17,18,19,20,21,22,23,
24,25,26,27,28,29,30,31}.

For example, the input of the AI model may include the measurement results related to the beam structure, such as {−98.1, −99, −102, −105}, where −98.1, −99, −102, and −105 correspond to the wide beam 0, wide beam 1, wide beam 2 and wide beam 3, respectively. The input of the AI model may also include the measurement results of the narrow beam corresponding to the optimal wide beam (for example, wide beam 0), for example, as shown in the following matrix:
{−98.1, NA,
NA, −103
NA, −99,
−105 NA}.

In the above matrix, ‘NA’ indicates that there is no corresponding measurement result, and −98.1, −103, −99 and 105 indicate the measurement results of beams corresponding to the corresponding matrix positions, respectively, and are in units of dB. Further, the information value corresponding to the time corresponding to the measurement may be input to the AI model. Alternatively, the measurements at different times may be represented by a higher-dimensional matrix.

A similar method may be used to construct an associated matrix for other information as input.

In some examples, the output of the AI model may include an ID of an optimal beam and/or a value of a predicted RSRP corresponding to the ID of the optimal beam.

For example, the training or inference of the AI model may be performed by the base station or UE. If the training and inference are not on the same side, the AI model may be signaled to the side that uses the AI model to perform inference.

In some examples, the UE may be in an RRC connected state. In this case, the following method may be used for beam management.

First, the UE determines the optimal receive antenna. The UE measures SSB (e.g., configured by csi-SSB-ResourceSet) or TRS. UE uses K receive beams to measure N transmit beams in SSB burst respectively, and determines the optimal receive beam corresponding to each transmit beam. This method may need to sweep K beams, which takes a long time.

The UE may measure CSI-RS (e.g., TRS) for beam management. Then the UE may determine the optimal receive beam for measuring CSI-RS according to the beam sweeping of SSB or TRS above. For example, for reference signals with the same TCI, the same receive beam is used for reception. Then, each reference signal corresponding to the measurement beam set is measured at least once to determine one or more optimal transmit beams. At this time, beam sweeping is not needed, which can save time. However, it may be due to the change of channel, or the optimal receive antenna has not been found at this time.

In addition, the measurement beam may be transmitted multiple times (e.g., configured to repetition on). Then, several CSI-RS in a period of time (such as a slot) may be considered to have the same TCI, and the UE can sweep with different receive beams to obtain the optimal receive beam, and/or the optimal transmit beam, and/or the optimal beam pair (i.e., the pair of the optimal receive beam and the optimal transmit beam).

An embodiment of a method of reporting measurement results (for example, Step S403) according to some embodiments of the disclosure is described below.

A reporting set SET_C is a set for a UE to perform reporting. The set SET_C may include one or more beams.

In some examples, the UE may obtain the reporting set SET_C by one or more of the following methods.

Method 4-1: A base station directly configures the reporting set SET_C to the UE. The UE performs measurement based on a measurement set SET_B and performs reporting to the base station based on the reporting set SET_C.

The reporting set SET_C may be a subset of the measurement set SET_B, or the reporting set SET_C may be the same as the measurement set SET_B.

Method 4-2: The base station configures a reportable set SET_C′ to the UE, and the UE selects element(s) in the reportable set SET_C′ as the set SET_C for reporting.

For example, the base station configures multiple reportable sets SET_C′ to the UE, and the UE selects at least one set of the reportable sets SET_C′ as the set SET_C for reporting.

The reportable set SET_C′ may be a set SETA corresponding to potential transmit beams, or a set formed by an intersection of the SETA and the SET_B.

According to the measurement results, the UE can select N optimal beams as the reporting set SET_C for reporting. N may be predefined or configured.

Or the UE may report beams whose measurement results are higher than a certain threshold as the reporting set SET_C for reporting. That is, beams below the threshold are discarded or ignored. For example, the threshold may be configured or defined in advance.

Or the UE may report N optimal beams whose measurement results are higher than a certain threshold as the reporting set SET_C for reporting.

Or the UE may select one or more optimal measurement results and one or more worst measurement results to report. For example, the UE may sort the measurement results and report the sorted measurement results according to predefined rules or a configuration by the base station. For example, the SET_B has 8 values, and the SET_C is reported with the 1st, 2nd, 5th and 8th measurement results in the sorted measurement results from best to worst. For example, the UE may report the beam ID and the measurement result corresponding to the beam:
{B1, L1-RSRP_B1;
B2, L1-RSRP_B2;
B5, L1-RSRP_B5;
B8, L1-RSRP_B8},
   where B1, B2, B5 and B8 are beam IDs, which may be indicated by 3 bits, for example; L1-RSRP_B1, L1-RSRP_B2, L1-RSRP_B5, and L1-RSRP_B8 represent the measurement results with 7 bits, respectively. A total of 40 bits is required.

Alternatively, the UE may indicate beam IDs corresponding to the reported measurements in the form of a bitmap, and the reporting format may be:
{Beam ID bitmap {0, 1, 1, 0, 0, 1, 0, 0, 1};
L1-RSRP_B1
L1-RSRP_B2;
L1-RSRP_B5;
L1-RSRP_B8}, where, in the bitmap, “1” means to report the measurement result of this beam, and 0 means not to report the measurement result of this beam. L1-RSRP_B1, L1-RSRP_B2, L1-RSRP_B5, and L1-RSRP_B8 represent the measurement results with 7 bits, respectively. A total of 8+7*4=36 bits is required, thereby saving 4 bits. In addition, the overhead can be further reduced by indicating an ID of a strongest beam, a measurement of the strongest beam, measurements of other beams, etc. (see the method of quantizing measurement results). Then, the report format in the above example can be represented as:
{Beam ID bitmap {0, 1, 1, 0, 0, 1, 0, 0, 1}
strongest beam ID B2, L1-RSRP_B2;
ΔL1-RSRP_B1
ΔL1-RSRP_B5;
ΔL1-RSRP_B8},
   where, the strongest beam ID B2 is quantized with 3 bits, the measurement L1-RSRP_B2 of the strongest beam is quantized with 7 bits, and each of the differences ΔL1-RSRP_B2, ΔL1-RSRP_B5, and ΔL1-RSRP_B8 between the reporting of other beams are quantized with 4 bits. Then this reporting requires 8+3+7+4*3=30 bits. The overhead can be further saved. Among them, the beam ID bitmap may be constructed according to the potential measurement beam set SETA or the measurement beam set SET_B.

Particularly, only ID(s) and measurement result(s) of a strongest beam or several strongest beams, as well as IDs of other strong beams for measurement, may be reported. For example, an ID and measurement result of 1 (or N, where N is a predefined or configured value) strongest beam is reported, and IDs of other beams whose measurement results are greater than a threshold are reported. Then, IDs of these other beams larger than the threshold may be reported directly or in a form of bitmap, such as
{Beam ID bitmap {0, 1, 1, 0, 0, 1, 0, 0, 1}
the strongest beam ID B2, L1-RSRP_B2}.

The beam ID bitmap may or may not include ID of one (or N) strongest beam. This situation may be regarded as a special way of quantification. Comparing the measurement result with a known threshold (which may be regarded as a quantization threshold), the measurement result exceeding this threshold is reported as 1, otherwise the result is reported as 0. At this time, the result is a 1-bit quantization result, or it can be seen that IDs of beams exceeding this threshold are reported in the form of a bitmap.

For example, the UE reports measurement results of wide beams (such as the measurement results of SSBs). Or further, measurement results of several narrow beams corresponding to an optimal wide beam may be reported (for example, the corresponding narrow beams selected in the above methods 3-1 to 3-3 are reported). Or the measurement results may be a subset of the measurement set. For example, measurement results of all wide beams and measurement results of all or a part of narrow beams, or measurement results of a part of wide beams (e.g., even number of SSBs), etc.

Or the UE may randomly select N elements in the measurement set SET_B as the reporting set SET_C for reporting.

In some examples, the UE may report based on the measurement timing and measurement results. For example, the optimal beam or beams at measurement time T0, T1, T2 and T3 are reported as the reporting set SET_C.

Or the UE may randomly select one or more sets from multiple reportable sets SET_C′ as the reporting set SET_C for reporting.

Or, according to the measurement result, the UE selects at least one set with the best measurement result from multiple reportable sets SET_C′ as the reporting set SET_C. The selecting at least one set with the best measurement results may be based on at least one of the following criteria: a maximum value of each beam measurement result in each set is the largest, an average value of all beam measurement results in each set is the largest, and a number of beams corresponding to measurements higher than a specific threshold in each set is the largest.

In some examples, the UE selects one or more sets as the SET_C for reporting according to different slots (or other time information) and/or UE related information. For example, sets (such as SET_C′0, SET_C′1, SET_C′2 and SET_C′3) in SET_C′ are respectively selected as SET_C for reporting at measurement times T0, T1, T2 and T3 according to specific rules.

The UE can select one or more sets according to the UE related information (such as moving speed information, location information, receive antenna (or beam) information, etc.) or N elements in the SET_C′ set as the reporting set SET_C for reporting.

If the UE selects one or more sets as the SEC_C for reporting, the UE needs to further report an ID of the SET_C set. If the UE selects one or more elements as the SEC_C for reporting, the UE needs to further report IDs corresponding to the elements (such as transmit beam, receive beam and beam pair).

The base station may train different AI models for the reportable set SET_C′, respectively, thus improving the performance. The base station can select an appropriate AI model as the AI input according to the ID of the reported SET_C set, to obtain required results.

Configuring multiple reporting sets, or selecting some elements in a reporting set as the reporting set can deal with the situation that the beam is blocked, thereby improving the system performance.

As an example, a number of elements in the reported set SET_C is greater than 4.

As an example, the number of elements in the reported SET_C is no more than 4.

In some examples, an associated time may be configured or predefined for the reporting set SET_C or one or more elements in the set SET_C. If the time is not configured, the latest measurement result in SET_C may be reported by default.

As an example, a result corresponding to a corresponding beam in the set SET_C at time T′ may be configured to be reported.

As an example, results corresponding to corresponding beams in the set SET_C at time set {T} may be configured to be reported.

For example, {time T1, set SET_C1}, {time T2, set SET_C2}, and {time T2, set SET_C3} are reported. For example, the sets SET_C1, SET_C2 and SET_C3 are the K optimal beams measured or predicted at times T1, T2 and T3, respectively. Further, the K optimal beam IDs and corresponding RSRP results may be reported.

If the time T is a time in the future, the reporting result is a predicted value. If T is a time in the past, the reporting result may be an actual measurement or a predicted value. For example, if the beam corresponding to the reporting result is not actually measured, but obtained by interpolation or prediction in the spatial domain, etc.

In some examples, the base station may configure the reporting set SET_C for the UE according to the measurement results reported by the UE in the past period TP of time.

For example, information such as measurement results reported by the UE in the past period of time TP may be input into an AI model (for example, the AI model described in various embodiments of the disclosure) for inference to obtain the UE-reporting set SET_C and/or a number N of elements in the set SET_C. The input parameters of the AI model may also include at least one of the following: transmit beam related information, receive beam related information, UE location information, UE speed information, UE moving direction, UE rotating direction, UE receiving angle, etc.

The application of an AI model in beam prediction includes:

(1) The AI Model May be Used to Predict One Optimal Downlink Beam in a Set SET_A.

If the AI model is implemented on the UE side, the UE may report the beam to a base station. The base station may use this beam for downlink transmission. In addition, the UE receives downlink data according to the optimal downlink beam. For example, if a downlink channel or signal is transmitted using multiple beams, the UE can receive the downlink transmission of the optimal downlink beam. At this time, the UE does not need to receive the same downlink transmission transmitted by other downlink beams. Further, the received downlink channel can be decoded, and the downlink reference signal can be measured, etc. If the AI model is implemented at the base station side, the base station can use the beam for downlink transmission.

This method may directly obtain the optimal beam and reduce the downlink pilot overhead.

(2) The AI Model May be Used to Predict K Optimal Downlink Beams in the Set SET_A.

If the AI model is implemented on the UE side, the UE may report the K optimal downlink beams to the base station (for example, recommend them to the base station as assistance information). If the AI model is implemented on the base station side, then the base station may directly obtain the K optimal downlink beams.

Further, the base station may configure the K optimal downlink beams reported by the UE or directly obtained by the base station according to the AI model to the UE for measurement. The UE may measure the K beams and report the measurement results. For example, at least one optimal beam (or CSI-RS information transmitted using the beam) and/or the measurement result of the at least one optimal beam (such as L1-RSRP). Further, the base station performs downlink transmission on the at least one optimal beam. Similarly, the UE receives downlink data according to the optimal downlink beam. For example, if a downlink channel or signal is transmitted with multiple beams, the UE can receive the downlink transmission of the optimal downlink beam. At this time, the UE does not need to receive the same downlink transmission transmitted by other downlink beams. Further, the received downlink channel can be decoded, and the downlink reference signal can be measured, etc.

In addition, the base station can select one or more of the one or more downlink beams directly for downlink data transmission.

After the AI model performs prediction of the one or K optimal downlink beams, the optimal downlink beams obtained by prediction may be further used to repeatedly transmit downlink reference signals (such as CSI-RS) multiple times, for the UE to perform beam sweeping of the receive beam to find the optimal receive beam for the downlink beam reception.

The method may directly obtain a set containing the optimal beam, thus reducing the pilot overhead caused by the measurement requited for obtaining the optimal beam.

(3) The AI Model May be Used to Predict an Optimal Beam Pair in the Set SET_A.

If the AI model is implemented on the UE side, the UE may report a downlink beam in the beam pair to the base station.

If the AI model is implemented on the base station side, the base station may use the downlink beam in the beam pair for downlink transmission. Further, the base station may configure or recommend a receive beam in the beam pair to the UE.

In addition, the UE receives the downlink data transmitted by the downlink beam in the beam pair with the receive beam pair in the beam pair. For example, if a downlink channel or signal is transmitted by using multiple downlink beams, the UE may use the receive beam in the beam pair to receive the downlink transmission transmitted by the downlink beam in the beam pair. At this time, the UE does not need to receive the same downlink transmission transmitted by other downlink beams, or the UE does not need to perform reception by other receive beams.

(4) The AI Model May be Used to Predict K Optimal Beam Pairs in the Set SET_A.

If the AI model is implemented on the UE side, the UE may report the downlink beams in the optimal K beam pairs to the base station (for example, recommend them to the base station as assistance information).

If the AI model is implemented on the base station side, the base station may directly obtain the downlink beams in the K optimal beam pairs. Further, the base station may configure or recommend the receive beams in the K beam pairs to the UE.

Further, the base station may configure downlink beams (one or more downlink beams) in the K optimal beam pairs reported by the UE or directly obtained by the base station according to the AI model to the UE for measurement. The UE may measure the downlink beam and report the measurement result. For example, if the UE obtains the receive beam corresponding to reception of the downlink beam through AI model prediction or according to a configuration by the base station, the UE may directly receive the corresponding downlink beam. The UE does not need to perform further receive beam sweeping. This method can reduce the reference signal required for receive beam scanning.

In addition, the base station may select one or more of the one or more downlink beams for direct downlink data transmission.

In order to save overhead, it is usually necessary to quantize measurement results to be reported, etc. The method of quantizing the measurement results is introduced below.

For example, L1-RSRP may be quantized with a quantization resolution of 1 dB. As shown in the quantization method of the first measurement in Table 1, the quantization is performed in a range of −140-−44 dBm with a resolution of 1 dB. 7 bits are needed for quantization. In order to reduce the number of reported bits, strongest beams may be quantized in a larger range with the resolution of 1 dB, while non-strongest beams may be quantized in a smaller range (for example, only 4 bits are needed for 0-30 dB), and even the quantization resolution can be further reduced (for example, only 3 bits are needed for 2 dB quantization in a range of 0-30 dB in Table 2).

In the model training and inference for AI prediction, more accurate reported values may provide better prediction performance. Therefore, the reported measurement range can be expanded. For example, if the mapping method of the second measurement in Table 1 is used for reporting, the measurement range of −156 dBm-−31 dBm may be reported.

In addition, as mentioned above, if the reported measurement set is known to the base station, only measurements of RSRP may be reported in a certain order without reporting the beam or CSI-RS ID. If all the measurements are quantized, then, since the bit number for quantization for each reported RSRP is the same, it is only necessary to quantize them in sequence. For example, SET_B={B1, B2, B3, B4} correspond reported measurement results {L1-RSRP_B1, L1-RSRP_B2, L1-RSRP_B3, L1-RSRP_B4}. If 7-bit quantization is used, it takes 28 bits to report the measurement results of 4 beams. A method is to report an ID of the strongest beam, a measurement of the strongest beam, and a difference between other beams and the measurement beam (it is different from the bit number for quantization of the measurement, for example, less than the bit number for quantization of the measurement).

At this time, because the reporting beam set is known in advance, if the ID of the strongest beam is known, the corresponding relationship of other beams may be obtained in a predetermined order. For example, SET_B={B1, B2, B3, B4} corresponds to the reported measurement result {strongest beam ID B2, L1-RSRP_B2; ΔL1-RSRP_B1, ΔL1-RSRP_B3, A L1-RSRP_B4}. Among them, the strongest beam ID B2 may be quantized by 2 bits (B1, B2, B3, and B4 are represented by {00, 01, 10, 11}, respectively). The quantized value of L1-RSRP_B2 corresponding to the strongest beam is quantized with 7 bits. The measurements of other beams are quantized with 4 bits, and excluding the strongest beam, the reporting is performed in the order of ΔL1-RSRP_B1, ΔL1-RSRP_B3 and ΔL1-RSRP_B4. A total of 2+7+4*3=21 bits is required, which saves the number of reported bits. If more beams need to be reported, more bits can be saved.

In an example, the ID of the reported strongest beam (CSI-TS) may be a beam (CSI-TS) ID defined in SETA. The beam (CSI-TS) ID may be predefined or configured. In a specific reporting format, an order of reported quantities such as the ID of the strongest beam, the measurement of the strongest beam, and the difference between other beams and the measurement beam may be arranged in other ways. For example, SET_B={B1, B2, B3, B4} corresponds to the reported measurement results {strongest beam ID B2, L1-RSRP_B1, ΔL1-RSRP_B2, ΔL1-RSRP_B3, ΔL1-RSRP_B4}. Since B2 is indicated as the strongest beam, L1-A RSRP_B1, ΔL1-RSRP_B3, and ΔL1-RSRP_B4 are indicated with few bits, while L1-RSRP_B2 is indicated with more bits.

In an example, a number of bits of each reported value and/or the reporting quantization method may be indicated in the form of a bitmap. For example, ‘0’ represents 4 bits or quantization by a difference value method, and ‘1’ represents 7 bits or quantization by an absolute value method. Then the above report can be denoted as {{0, 1, 0, 0}, ΔL1-RSRP_B1, L1-RSRP_B2, ΔL1-RSRP_B3, ΔL1-RSRP_B4}.

In addition, a smaller quantization step size, such as 1 dB, may also be used for difference value reporting. Alternatively, unequal quantization step sizes may be used, such as the report mapping of the second measurement in Table 2, which may be performed with 3 bits. When the difference with the strongest beam is small, a smaller quantization step size (such as 1 dB) may be adopted, while when the difference with the strongest beam is large, a larger quantization step size (such as 4 dB) may be adopted. In this way, the relatively strong results can be accurately reported under a certain quantization overhead, thus further reducing the overhead. For example, only the measurement result of the strongest beam and IDs of other beams may be reported. If the set reported is not a set known in advance, it is necessary to further indicate the beam ID. For example, a threshold (which can be regarded as a quantization threshold) may be configured or defined, and the measurement result exceeding this threshold is reported as 1, otherwise the result is reported as 0.

The above quantization methods may be determined according to a configuration by the base station and/or predefined rules. For example, it may be configured or predetermined for different purposes (such as a data collection stage (for training and/or testing) or inference stage) or different reporting overhead, or different reported values, and the UE uses different resolutions to perform quantization. For example, the base station directly configures one of multiple predefined quantization resolutions (such as one of the first measurement and the second measurement in Table 1) and/or methods (such as a method of directly reporting the measurement and/or a method of reporting the difference with the maximum value) to the UE by RRC. Different predefined measurement report mappings may have different ranges and/or different quantization resolutions.

In addition, because different AI/ML models have different sensitivity to the measurement results of the input model, the base station or server may directly configure a measurement report mapping table to the UE by RRC and other means. For example, by configuring the quantization range and/or quantization resolutions of the quantization table, the UE may obtain the quantization mapping table through predefined rules (such as equally spaced quantization). Or one or more quantization tables may be configured directly by RRC messages. Although this method may have a large one-time configuration overhead, compared with a large number of reported data, it can still save some reporting overhead in total.

TABLE 1
Mapping of RSRP Measurement Report

| Reported | First | Second | |
|---|---|---|---|
| value | measurement | measurement | Unit |
| RSRP_0 | Not valid | RSRP < −156 | dBm |
| RSRP_1 | Not valid | −156 ≤ RSRP < −155 | dBm |
| RSRP_2 | Not valid | −155 ≤ RSRP < −154 | dBm |
| RSRP_3 | Not valid | −154 ≤ RSRP < −153 | dBm |
| RSRP_4 | Not valid | −153 ≤ RSRP < −152 | dBm |
| RSRP_5 | Not valid | −152 ≤ RSRP < −151 | dBm |
| RSRP_6 | Not valid | −151 ≤ RSRP < −150 | dBm |
| RSRP_7 | Not valid | −150 ≤ RSRP < −149 | dBm |
| RSRP_8 | Not valid | −149 ≤ RSRP < −148 | dBm |
| RSRP_9 | Not valid | −148 ≤ RSRP < −147 | dBm |
| RSRP_10 | Not valid | −147 ≤ RSRP < −146 | dBm |
| RSRP_11 | Not valid | −146 ≤ RSRP < −145 | dBm |
| RSRP_12 | Not valid | −145 ≤ RSRP < −144 | dBm |
| RSRP_13 | Not valid | −144 ≤ RSRP < −143 | dBm |
| RSRP_14 | Not valid | −143 ≤ RSRP < −142 | dBm |
| RSRP_15 | Not valid | −142 ≤ RSRP < −141 | dBm |
| RSRP_16 | RSRP < −140 | −141 ≤ RSRP < −140 | dBm |
| RSRP_17 | −140 ≤ RSRP < −139 | −140 ≤ RSRP < −139 | dBm |
| RSRP_18 | −139 ≤ RSRP < −138 | −139 ≤ RSRP < −138 | dBm |
| . . . | | . . . | . . . |
| RSRP_111 | −46 ≤ RSRP < −45 | −46 ≤ RSRP < −45 | dBm |
| RSRP_112 | −45 ≤ RSRP < −44 | −45 ≤ RSRP < −44 | dBm |
| RSRP_113 | −44 ≤ RSRP | −44 ≤ RSRP < −43 | dBm |
| RSRP_114 | Not valid | −43 ≤ RSRP < −42 | dBm |
| RSRP_115 | Not valid | −42 ≤ RSRP < −41 | dBm |
| RSRP_116 | Not valid | −41 ≤ RSRP < −40 | dBm |
| RSRP_117 | Not valid | −40 ≤ RSRP < −39 | dBm |
| RSRP_118 | Not valid | −39 ≤ RSRP < −38 | dBm |
| RSRP_119 | Not valid | −38 ≤ RSRP < −37 | dBm |
| RSRP_120 | Not valid | −37 ≤ RSRP < −36 | dBm |
| RSRP_121 | Not valid | −36 ≤ RSRP < −35 | dBm |
| RSRP_122 | Not valid | −35 ≤ RSRP < −34 | dBm |
| RSRP_123 | Not valid | −34 ≤ RSRP < −33 | dBm |
| RSRP_124 | Not valid | −33 ≤ RSRP < −32 | dBm |
| RSRP_125 | Not valid | −32 ≤ RSRP < −31 | dBm |
| RSRP_126 | Not valid | −31 ≤ RSRP | dBm |
| RSRP_127 | infinite | infinite | dBm |

TABLE 2
Mapping of RSRP Measurement Report Difference

| | First | Second | |
|---|---|---|---|
| | measurement | measurement | |
| | (difference with | (difference with | |
| | the strongest | the strongest | |
| Reported value | RSRP) | RSRP) | unit |
| DIFFRSRP_0 | 0 ≥ ΔRSRP > −2 | 0 ≥ ΔRSRP > −1 | dB |
| DIFFRSRP_1 | −2 ≥ ΔRSRP > −4 | −1 ≥ ΔRSRP > −2 | dB |
| DIFFRSRP_2 | −4 ≥ ΔRSRP > −6 | −2 ≥ ΔRSRP > −4 | dB |
| DIFFRSRP_3 | −6 ≥ ΔRSRP > −8 | −4 ≥ ΔRSRP > −6 | dB |
| DIFFRSRP_4 | −8 ≥ ΔRSRP > −10 | −6 ≥ ΔRSRP > −8 | dB |
| DIFFRSRP_5 | −10 ≥ ΔRSRP > −12 | −8 ≥ ΔRSRP > −10 | dB |
| DIFFRSRP_6 | −12 ≥ ΔRSRP > −14 | −10 ≥ ΔRSRP > −14 | dB |
| DIFFRSRP_7 | −14 ≥ ΔRSRP > −16 | −14 ≥ ΔRSRP > −20 | dB |
| DIFFRSRP_8 | −16 ≥ ΔRSRP > −18 | NA | dB |
| DIFFRSRP_9 | −18 ≥ ΔRSRP > −20 | NA | dB |
| DIFFRSRP_10 | −20 ≥ ΔRSRP > −22 | NA | dB |
| DIFFRSRP_11 | −22 ≥ ΔRSRP > −24 | NA | dB |
| DIFFRSRP_12 | −24 ≥ ΔRSRP > −26 | NA | dB |
| DIFFRSRP_13 | −26 ≥ ΔRSRP > −28 | NA | dB |
| DIFFRSRP_14 | −28 ≥ ΔRSRP > −30 | NA | dB |
| DIFFRSRP_15 | −30 ≥ ΔRSRP | NA | dB |

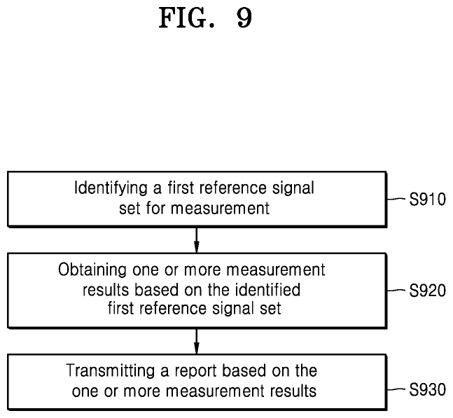

FIG. 9 illustrates a flowchart of a method performed by a UE according to an embodiment of the present disclosure.

Referring to FIG. 9, in operation S910, the UE identifies a first reference signal set (e.g., the set SET_B described in the embodiments of the disclosure) for measurement.

With continued reference to FIG. 9, in operation S920, the UE obtains one or more measurement results based on the identified first reference signal set.

Next, in operation S930, the UE transmitting a report based on the one or more measurement results.

In some examples, for example, the determining a first reference signal set for measurement includes: determining a first reference signal set based on first configuration information configuring the first reference signal set that is received from a base station, where the first reference signal set configured by the first configuration information is obtained by the base station by using a first AI model (for example, various AI models described in embodiments of the disclosure).

In some examples, for example, the determining a first reference signal set for measurement includes obtaining a first reference signal set by using the first AI model.

In some examples, for example, the first AI model is trained to output the first reference signal set based on at least one of the following:
information on one or more potential transmit beams;
information on one or more measured transmit beams;
information on a reference signal set corresponding to the one or more potential transmit beams;
information on one or more measured reference signal sets;
measurement results of the one or more measured transmit beams;
information on a relationship between the one or more measured transmit beams and the one or more potential transmit beams;
information on a relationship between the first reference signal set and the reference signal set corresponding to the one or more potential transmit beams;
time information on the first reference signal set; and/or
UE-related information.

In some examples, for example, the determining a first reference signal set for measurement includes: determining a set of synchronization signals/physical broadcast channel blocks (SSBs) for measurement as the first reference signal set.

In some examples, for example, the determining a first reference signal set for measurement includes: determining the first reference signal set based on a reference signal set corresponding to one or more potential transmit beams configured by the base station.

In some examples, for example, the performing measurement to obtain one or more measurement results based on the determined first reference signal set includes measuring at least one of the following: reference signals corresponding to one or more wide transmit beams in the determined first reference signal set; or reference signals corresponding to one or more narrow transmit beams in the determined first reference signal set. The one or more narrow transmit beams are determined based on measurement results of reference signals corresponding to the one or more wide transmit beams.

In some examples, for example, the one or more narrow transmit beams are determined as one or more narrow transmit beams associated with at least one of the one or more wide transmit beams, and a measurement result of reference signal corresponding to the at least one wide transmit beam is superior to measurement results of reference signals corresponding to wide transmit beams of the one or more wide transmit beams other than the at least one wide transmit beam.

In some examples, for example, the performing measurement to obtain one or more measurement results based on the determined first reference signal set includes: performing measurement on the determined first reference signal set to obtain measurement results corresponding to the first reference signal set; obtaining one or more measurement results corresponding to a second reference signal set (for example, the set SET_C described in the embodiments of the disclosure) by using a second AI model (for example, various AI models described in the embodiments of the disclosure) based on the measurement result corresponding to the first reference signal set. The second reference signal set is different from the first reference signal set.

In some examples, for example, the second AI model is trained to output one or more measurement results corresponding to the second reference signal set based on at least one of the following:
information on one or more potential transmit beams;
information on one or more measured transmit beams;
information on a reference signal set corresponding to one or more potential transmit beams;
information on one or more measured reference signal sets;
measurement results of the one or more measured transmit beams;
information on a relationship between the one or more measured transmit beams and the one or more potential transmit beams;
information on a relationship between the first reference signal set and the reference signal set corresponding to the one or more potential transmit beams;
time information on one or more measurement results corresponding to the second reference signal set; and/or
UE-related information.

In some examples, for example, the performing reporting based on the one or more measurement results includes: reporting at least one of (i) at least one measurement result of the one or more measurement results or (ii) information related to a reference signal or a beam corresponding to the at least one measurement result.

In some examples, for example, the second reference signal set is determined based on at least one of the following:
the second reference signal set is the first reference signal set or a subset of the first reference signal set;
the second reference signal set is a reference signal set corresponding to one or more potential transmit beams;
the second reference signal is a reference signal set corresponding to a predetermined number of measurement results among the one or more measurement results, where the predetermined number of measurement results are superior to measurement results among the one or more measurement results other than the predetermined number of measurement results; and/or
the second reference signal set is a reference signal set corresponding to measurement results higher than a predefined threshold among the one or more measurement results.

In some examples, for example, at least one measurement result of the one or more measurement results includes one or more optimal measurement results among measurement results associated with measurement times of corresponding reference signals in the second reference signal set.

In some examples, for example, the UE-related information includes at least one of the following: information on a location of the UE, information on a speed of the UE, information on a moving direction of the UE, information on one or more receive beams of the UE, information on a rotating direction of the UE, or information on a receiving angle of the UE.

In some examples, one or more of operations S910-S930 may be performed based on methods described according to various embodiments of the disclosure.

In some examples, the methods described above may omit some operations or include additional operations, such as those performed by a terminal (e.g., UE) according to various embodiments of the disclosure.

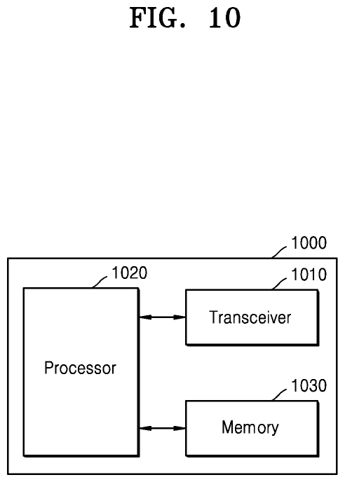

FIG. 10 illustrates a configuration of a terminal (e.g., UE) according to some embodiments of the present disclosure.

Referring to FIG. 10, a terminal 1000 according to an embodiment of the disclosure may include a transceiver 1010, at least one processor 1020 and a memory 1030. The terminal may be implemented to include more or less elements than those shown in FIG. 10.

The transceiver 1010 may transmit or receive signals to or from another terminal, base station and/or network entity. The transceiver 1010 may receive, for example, downlink data packets from the base station and may transmit uplink data packets to the base station.

The processor 1020 may control the overall operation of the terminal. For example, the processor 1020 may control the transceiver 1010 and the memory 1030 to implement the method for measuring or reporting of measurement results described according to various embodiments of the disclosure.

The memory 1030 may store information, data, programs, instructions and/or the like to be processed by the terminal. For example, the memory 1030 may store the first AI model or the second AI model as described above or the AI models described according to various embodiments of the disclosure, or related training data.

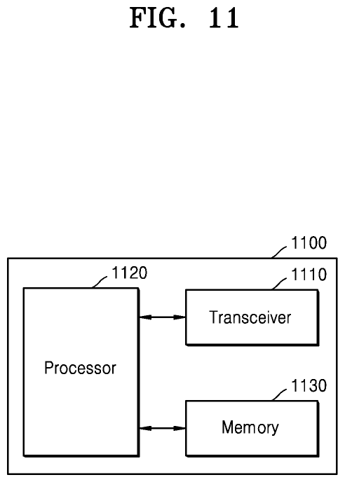

FIG. 11 illustrates a configuration of a base station according to some embodiments of the present disclosure.

Referring to FIG. 11, the base station 1100 according to the above embodiment may include a transceiver 1110, at least one base station processor 1120 and a memory 1130. The base station may be implemented to include more or less elements than those shown in FIG. 11.

The transceiver 1110 may transmit or receive signals to or from a terminal, another base station and/or a network entity. The transceiver 1110 may, for example, receive an uplink data packet from a terminal and may transmit a downlink data packet to the terminal.

The processor 1120 may control the overall operation of the base station. For example, the processor 1120 may control the transceiver 1110 and the memory 1130 to implement the method for measurement and reporting of measurement results according to various embodiments of the disclosure.

The memory 1130 may store information, data, programs, instructions and/or the like to be processed by the base station. For example, the memory 1130 may store the first AI model or the second AI model as described above or the AI models described according to various embodiments of the disclosure, or related training data.

Those skilled in the art will understand that the illustrative embodiments described above are described herein and are not intended to be limiting. It should be understood that any two or more of the embodiments disclosed herein can be combined in any combination. In addition, other embodiments may be utilized and other changes may be made without departing from the spirit and scope of the subject matter presented herein. It will be readily understood that aspects of the disclosure, as generally described herein and shown in the drawings, can be arranged, substituted, combined, separated, and designed in various different configurations, all of which are contemplated herein.

Those skilled in the art will appreciate that the various illustrative logical blocks, modules, circuits, and steps described herein may be implemented as hardware, software, or a combination of both. In order to clearly illustrate this interchangeability between hardware and software, various illustrative components, blocks, modules, circuits, and steps are generally described in the form of their function sets. Whether such function sets are implemented as hardware or software depends on the specific application and the design constraints imposed on the overall system. Skilled people can implement the described function sets in different ways for each specific application, but such design decisions should not be interpreted as causing a departure from the scope of this application.

The various illustrative logic blocks, modules, and circuits described in this application may be implemented or performed in a general-purpose processor, a digital signal processor (DSP), an application specific integrated circuit (ASIC), a field programmable gate array (FPGA) or other programmable logic devices, discrete gates or transistor logics, discrete hardware components, or any combination thereof designed to perform the functions described herein. A general-purpose processor may be a microprocessor, but in the alternative, a processor may be any conventional processor, controller, microcontroller, or state machine. A processor may also be implemented as a combination of computing devices, such as a combination of a DSP and a microprocessor, multiple microprocessors, one or more microprocessors cooperating with a DSP core, or any other such configuration.

The steps of a method or algorithm described in this application may be embodied directly in hardware, in a software module executed by a processor, or in a combination of the two. Software modules may reside in RAM memory, flash memory, ROM memory, EPROM memory, EEPROM memory, registers, hard disks, removable disks, or any other form of storage media known in the art. An exemplary storage medium is coupled to a processor to enable the processor to read and write information from/to the storage medium. In the alternative, the storage medium may be integrated into the processor. The processor and the storage medium may reside in an ASIC. The ASIC may reside in a user terminal. In the alternative, the processor and the storage medium may reside as separate components in the user terminal.

In one or more exemplary designs, the described functions may be implemented in hardware, software, firmware, or any combination thereof. If implemented in software, each function may be stored on or transmitted by a computer-readable medium as one or more instructions or codes. Computer-readable media include both computer storage media and communication media, and the latter includes any media that facilitates the transfer of computer programs from one place to another. The storage medium may be any available medium that can be accessed by a general-purpose or special-purpose computer.

The above are only exemplary implementations of the disclosure, and are not used to limit the scope of protection of the disclosure, which is determined by the appended claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
identifying a first reference signal set for a measurement operation;
obtaining one or more measurement results based on the identified first reference signal set; and
transmitting a report based on the one or more measurement results,
wherein the first reference signal set is generated based on a first artificial intelligence (AI) model, and
wherein the one or more measurement results are generated based on a second AI model.

2. The method of claim 1, wherein identifying the first reference signal set comprises:
receiving, from a base station, first configuration information; and
identifying the first reference signal set based on first configuration information, and
wherein the first reference signal set that is configured by the first configuration information is obtained using the first AI model.

3. The method of claim 2, wherein the first AI model is trained to output the first reference signal set based on at least one of:
information on one or more potential transmit beams;
information on one or more measured transmit beams;
information on a reference signal set corresponding to the one or more potential transmit beams;
information on one or more measured reference signal sets;
measurement results of the one or more measured transmit beams;
information on a relationship between the one or more measured transmit beams and the one or more potential transmit beams;
information on a relationship between the first reference signal set and the reference signal set corresponding to the one or more potential transmit beams;
time information on the first reference signal set; or
UE-related information.

4. The method of claim 3, wherein the UE-related information includes at least one of:
information on a location of the UE;
information on a speed of the UE;
information on a moving direction of the UE;
information on one or more receive beams of the UE;
information on a rotating direction of the UE; or
information on a receiving angle of the UE.

5. The method of claim 1, wherein identifying the first reference signal set comprises:
identifying a set of synchronization signals/physical broadcast channel blocks (SSBs) as the first reference signal set.

6. The method of claim 1, wherein identifying the first reference signal set for the measurement operation comprises:
identifying the first reference signal set based on reference signal sets corresponding to one or more potential transmit beams configured by a base station.

7. The method of claim 1, wherein obtaining one or more measurement results based on the identified first reference signal set comprises:
obtaining at least one of a reference signal corresponding to one or more first wide transmit beams in the identified first reference signal set, or a reference signal corresponding to one or more narrow transmit beams in the identified first reference signal set, and
wherein the one or more narrow transmit beams are identified based on measurement results of reference signals corresponding to the one or more first wide transmit beams.

8. The method of claim 7, wherein the one or more narrow transmit beams are associated with at least one second wide transmit beam of the one or more first wide transmit beams, and
wherein the measurement results of the reference signals corresponding to the at least one second wide transmit beam include higher priority than measurement results of reference signals corresponding to wide transmit beams of the one or more second wide transmit beams other than the at least one second wide transmit beam.

9. The method of claim 1, wherein obtaining one or more measurement results based on the identified first reference signal set comprises:
obtaining one or more measurement results corresponding to a second reference signal set using the second AI model based on the measurement results corresponding to the first reference signal set, and
wherein the second reference signal set is different from the first reference signal set.

10. The method of claim 9, wherein the second AI model is trained to output one or more measurement results corresponding to the second reference signal set based on at least one of:
information on one or more potential transmit beams;
information on one or more measured transmit beams;
information on a reference signal set corresponding to the one or more potential transmit beams;
information on one or more measured reference signal sets;
measurement results of the one or more measured transmit beams;
information on a relationship between the one or more measured transmit beams and the one or more potential transmit beams;
information on a relationship between the first reference signal set and the reference signal set corresponding to the one or more potential transmit beams;
time information on one or more measurement results corresponding to the second reference signal set; or
UE-related information.

11. The method of claim 9, wherein the second reference signal set is determined based on at least one of:
the second reference signal set being the first reference signal set or a subset of the first reference signal set;
the second reference signal set being a reference signal set corresponding to one or more potential transmit beams;
the second reference signal being a reference signal set corresponding to a predetermined number of measurement results among the one or more measurement results, the predetermined number of measurement results including higher priority than measurement results among the one or more measurement results other than the predetermined number of measurement results; or
the second reference signal set being a reference signal set corresponding to measurement results higher than a predefined threshold among the one or more measurement results.

12. The method of claim 1, wherein the report includes at least one of (i) at least one reporting measurement result of the one or more measurement results or (ii) information related to a reference signal or a beam corresponding to the at least one reporting measurement result.

13. The method of claim 12, wherein the at least one reporting measurement result includes one or more optimal measurement results among measurement results associated with measurement times of corresponding reference signals in a second reference signal set.

14. A user equipment (UE) in a wireless communication system, the UE comprising:
a transceiver; and
at least one processor coupled to the transceiver and configured to
identify a first reference signal set for a measurement operation,
obtain one or more measurement results based on the identified first reference signal set, and
transmit a report based on the one or more measurement results,
wherein the first reference signal set is generated based on a first artificial intelligence (AI) model, and
wherein the one or more measurement results are generated based on a second AI model.

15. A method performed by a base station in a wireless communication system, the method comprising:
identifying a first reference signal set, wherein the first reference signal set is used by a user equipment (UE); and
receiving a report of one or more measurement results from the UE,
wherein the first reference signal set is generated based on a first artificial intelligence (AI) model, and
wherein the one or more measurement results are generated based on a second AI model.
